(19) United States
(12) Patent Application Publication
(10) Pub. No.: US 2025/0130374 A1
(43) Pub. Date: Apr. 24, 2025

(54) PRE-TERMINATED OPTICAL FIBRE CABLE ASSEMBLY, KITS OF PARTS, METHODS OF MANUFACTURE AND INSTALLATION THEREOF

(71) Applicant: EMTELLE UK LTD, Hawick (GB)

(72) Inventors: Eben Colin KIRKPATRICK, Hawick (GB); William George RAE, Hawick (GB)

(73) Assignee: EMTELLE UK LTD, Hawick (GB)

(21) Appl. No.: 18/682,197

(22) PCT Filed: Aug. 1, 2022
(86) PCT No.: PCT/EP2022/071493

§ 371 Date: Feb. 8, 2024

(30) Foreign Application Priority Data
Aug. 12, 2021 (GB) 2111589.4

(51) Int. Cl. G02B 6/38; G02B 6/44; G02B 6/52

(52) U.S. Cl. CPC G02B 6/3869; G02B 6/3821; G02B 6/443; G02B 6/4438; G02B 6/52

(57) ABSTRACT

A pre-terminated cable assembly (600, 700) comprises a length of cable (110) in which one or more optical fibres (306) are embedded in a solid resin material (320) to form a coated fibre bundle. An extruded polymer sheath (324) covers the coated fibre bundle. A ferrule sub-assembly (124, 602, 604, 606) is pre-arranged on a leading end of the cable. A restraining part (604 or 708) is bonded to a portion of the sheath. After passing through a duct, the sub-assembly (124) becomes part of a pluggable connector (500, 502, 504, 506). When a pull-out force is applied to the cable (110), the restraining part transfers at least 25 N of force to the connector body (502, 504, 506), while force on the optical fibre (306) remains below 5 N. The transferred force is sufficient to unplug the connector (500) before any damage occurs to the fibre.

### FIELD OF THE INVENTION

The present invention relates to improved pre-terminated (also called “pre-connectorised”) optical fibre cables. The invention further relates to methods of manufacture and installation of pre-terminated optical fibre cables.

### BACKGROUND TO THE INVENTION

Optical fibres can be installed through a duct, for example a so-called micro-duct, using compressed gas or fluid, for example air. This is known as installation by blowing, and special lightweight cable assemblies known as “fibre units” have been developed for this installation method. Optical fibres can also be installed by pushing, or pulling, or preinstalled in a duct. Different cable designs can be used for these different methods. For example, a cable adapted for installation by pulling may include strengthening fibres, surrounding the optical fibres and all contained within an outer sheath.

Fibre to the home (FTTH) is the generic term for broadband network architecture that uses optical fibre technology to carry data to a residential dwelling from a broadband service provider via a telecommunications cabinet located near the residential dwelling. Embodiments of the present invention may be applied in FTTH applications, or in installation of optical fibres to a variety of premises (FTTx) and within premises.

Using the blowing process to install optical fibres into an optical fibre duct typically uses viscous drag generated by a high-speed flow of a fluid, for example air. This process is described in many patent publications, for example EP108590 and EP2074456. EP108590 describes pressurised air being pumped into a chamber in a blowing head. The air is directed through a tube at the blowing head and into a duct. The fibre unit containing one or more optical fibres is fed into the tube by a pushing force, between a pair of motorised drive rollers.

When a sufficient length of fibre unit has been pushed into the duct, the pressurised air works on the fibre surface allowing the effects of viscous drag to take over, at least partly, the task of advancing the transmission line along the duct until the fibre unit exits the far end of the duct at the desired location.

Several different constructions of fibre units have been designed specifically for installation by blowing. To be successful, such units require to be lightweight, but have a certain stiffness. There is also a significant requirement for fibre units to be compact, for example being around 2 mm or less, often less than 1.5 mm in diameter, when only a few fibres are involved. One type of fibre unit adapted to be installed by the blowing process comprises a number of optical fibres embedded in a solid resin, for example a UV-cured acrylate resin, which locks the fibres in a unitary matrix. This coated fibre bundle is then covered by an outer sheath, for example a sheath or sleeve of low friction, thermoplastic material. The sheath material typically comprises HDPE with a friction-reducing additive. Examples of this type of fibre unit are disclosed for example in WO2004015475A2. Another patent application WO2019053146A1 describes a fibre unit for blowing which is distinguished by a degree of cross-linking being applied in the HDPE sheath. This fibre unit has also been exploited commercially in recent years.

As mentioned above, pulling is another example of installing an optical fire transmission line into and through a duct. This process involves applying a pulling load to the leading end of the transmission line. The transmission line can be pulled by applying the load directly to the leading end of the transmission line or via a carriage device, which carries the leading end of the transmission line. The pulling load may be applied via the exit end of the duct using a pulling line previously installed in the duct. A pulling force can also be applied using air resistance, for example by fitting an “umbrella” or “parachute” accessory to the leading end of the transmission line, and pumping air into the trailing end of the duct. (This is not the same as installation by blowing, because the cable has to be able to withstand pulling forces from the front end, rather than being propelled by a drag force applied along its full length.)

“Tensile performance” of the cable may be specified maximum force (tension) permitted for a given product before the optical performance is affected/destroyed. The maximum force permitted on an individual fibre is sometimes expressed as a fraction of the “proof strain”, being a degree of tension at which the optical performance of the fibre has been tested in manufacture. It may be specified, for example, that the tension on any individual fibre should not exceed 5 N. The maximum force on the cable as a whole is derived from that, but then depends on the construction of the product, including the properties of any sheath/unit tube and properties of the individual fibres within. Another force unit that may be used in measuring tensile performance of cables is the “W” unit, being the weight of a one-kilometre length of the cable product in question. The parameter W can therefore be used to obtain expressions of tensile force such as “1W” or “W/3”, which adapt automatically to different products. In practice different limits may be specified for transient conditions during installation, and long-term conditions during operation).

In order to reduce the risk of faulty installations, and to speed up the installation this requirement for specialist skills and equipment, there is a trend to use pre-terminated or “pre-connectorised” cable assemblies. At one or both ends of a pre-terminated optical fibre, one or two ferrule sub-assemblies are generally attached to one or two optical fibres respectively, prior to installing the optical fibres between the consumer site, for example a residential dwelling and a supply site, for example a telecommunication cabinet. An optical ferrule is typically a cylinder of material (for example zirconia, ceramic or plastic), having a small bore into which the glass element of the optical fibre is inserted and cemented, and whose end is then polished to mate with a corresponding ferrule in a mating connector. A mechanical ferrule holder can be provided as part of the ferrule sub-assembly, optionally with a compression spring as well. A blowable ferrule sub-assembly is sized to be small enough to pass through the typical micro-duct, after it has been mounted at the leading end of the fibre unit. It will be understood that such connectors avoid the need for splicing to pass signals from one fibre to another.

Following installation of the pre-terminated fibre unit through a duct, a connector body can be fitted to the ferrule sub-assembly to complete the functional connector. For example, an LC type connector (“local connector”) may be provided at the cabinet end, and an SC type connector (“subscriber connector”) at the premises end. Example connectors are described in EP1972974, EP2012152, EP2012153, EP1783523, EP1783524, EP1783522, GB2558567A and GB2589365A. Of course other types of connector are available.

Regardless of pulling forces in the installation process, pulling forces may also arise by accident, after installation, especially where the terminated ends of the fibre unit are exposed in the premises, a street cabinet or equipment room. GB2589365A, mentioned above, describes a modification of the traditional LC connector (local connector), in which the pull-out force, after the connector body has been latched into a matching socket, is limited to a moderate value, such as 20-25 N. An SC connector with limited pull-out force of 20 N may also be conceived. GB2558567A mentioned above describes a blowable ferrule sub-assembly for making a pre-terminated cable compatible with an SC plug body. Even with these safeguards, that pull-out force is clearly greater than the force permitted on the fibre which is coupled to the optical ferrule. Without additional protection, pulling on these cables, for example by accident, will result in a broken fibre, requiring costly field repair, not to mention service interruption.

This process of installation leaves an exposed length of the fibre unit within the cabinet, between the end of the duct and the mating connector. The exposed length needs to be protected against damage. A known method of protection is to apply a woven or braided tube or sheath that can be fitted over the length of the transmission line that exits the duct, prior to fitting a connector body to the optical ferrule. It was found that fitting a manufactured length of the woven or braided tube pre-fitted with collars/connectors can be problematic. To avoid this, patent application WO2018146470A1 proposes to pre-assemble a blowable protective sleeve onto a leading portion of the fibre unit, behind the blowable optical ferrule.

The blowable sleeve of WO2018146470A1 successfully protects the protruding ends of lightweight fibre units, of the type blown through micro-ducts to communications cabinets, or consumer premises. Installation is very simple. However, the protective sleeve and additional assembly steps naturally increase the cost of the product, both in terms of components and manufacturing process. The sleeve also adds weight and stiffness to the leading portion of the cable, affecting installation distance slightly.

### SUMMARY OF THE INVENTION

A first aspect of the present invention provides a pre-terminated optical fibre cable assembly configured to be installed through a duct, the pre-terminated optical fibre cable assembly comprising:
a length of cable comprising at least one optical fibre embedded in a solid resin material to form a coated fibre bundle and an extruded polymer sheath covering the coated fibre bundle;
a ferrule sub-assembly pre-arranged on at least a leading end of the cable, the ferrule sub-assembly being adapted to become, after installation through said duct, part of a pluggable optical connector for making an optical connection to said at least one optical fibre; and
a restraining part fixed to a portion of said extruded polymer sheath, the restraining part being optionally part of said ferrule sub-assembly, the restraining part being adapted, when said ferrule sub-assembly becomes part of said pluggable connector and when a pull-out force is applied to said pluggable connector by pulling on a trailing portion of the cable, to transfer at least 25 N of said pull-out force to a body of said pluggable connector while any of said pull-out force transferred to said optical fibre remains less than 5 N.

The pre-terminated cable assembly of the invention can be manufactured in a factory, with high precision and efficiency, with only simple steps being required for installation in the field. After passing through a duct, and after the sub-assembly becomes part of a suitable pluggable connector, the optical fibre can be protected at least to an extent against damage, without the need for additional sleeves or layers of reinforcing yarns. With suitable choice of connector body, it can be ensured that the transferred force is sufficient to unplug the connector before any damage occurs to the fibre.

In some embodiments, said ferrule sub-assembly includes an optical ferrule and a ferrule holder, said optical ferrule being seated in a forward part of said ferrule holder, said optical fibre being passed through a bore of said ferrule holder and being inserted within a bore of said optical ferrule.

In some embodiments, said ferrule sub-assembly further includes a spring for biasing the ferrule sub-assembly into contact with a mating connector, said optical fibre being passed through a bore of said spring, said spring being seated in a rear part of said ferrule holder.

In particular embodiments an end portion of said cable including said portion of extruded polymer sheath is passed through the bore of said spring and at least partly into a rear part of said ferrule holder.

In some embodiments, said restraining part is fixed to said portion of the sheath by bonding. The bonding may be by a thermoset resin, for example epoxy resin. The bonding may be by a hot melt adhesive, as another example.

The extruded polymer sheath may be of a material having a tensile modulus in excess of 1500 MPa, optionally in excess of 2000 MPa, optionally in excess of 2200 MPa and optionally in excess of 2400 MPa.

The extruded polymer sheath may be of a material having a yield strength in excess of 30 MPa, optionally in excess of 40 MPa.

In some embodiments, the extruded polymer sheath comprises a mixture of polybutylene terephthalate polymer, PBT and at least one friction reducing additive.

The friction reducing additive may for example comprise a polydimethylsiloxane material, PDMS in a carrier material.

The PDMS may be an ultra-high molecular weight PDMS and said carrier material may be a polyacrylate material, for example a copolymer of ethylene and methyl acrylate, EMA.

Alternatively, or in addition, the PDMS may be an ultra-high molecular weight PDMS and said carrier material is a polyolefin, such as low-density polyethylene (LPDE).

According to some embodiments, the additive comprises at least 40% by weight ultra-high molecular weight PDMS and the carrier material is low-density polyethylene (LPDE).

According to some embodiments, the solid resin material of said coated fibre bundle is a UV-cured resin such as an acrylate material and has a tensile modulus greater than 100 MPa, optionally in the range 250-700 MPa.

For installation by blowing, the cable may be similar in structure to the blown fibre unit of WO2004015475A2. In one such example, the number of optical fibres including any mechanical fibre is up to four and an outer diameter of said cable is less than 1.2 mm, optionally less than 1.1 mm. In other such examples, the number of optical fibres including any mechanical fibre is up to 6, 8, 12 or 24 fibres and an outer diameter of the fibre unit is less than 1.3, 1.5, 1.6 and 2.1 mm, respectively.

In other embodiments, the fibre optic cable is adapted to be installed by pushing, and an outer diameter of the fibre unit is in the range of 1.5 to 2.5 mm, for example in the range 1.9 to 2.2 millimetres, for example 2.0 to 2.1 mm. In some such embodiments, one or more strength members, for example an FRP strength member, is embedded together with said one or more optical fibres within said coated fibre bundle. The same fibre optic cable in practice can be suitable for blowing as well as pushing.

The invention in a second aspect provides a method of assembling a pre-terminated optical fibre cable assembly configured to be installed through a duct, the method comprises the steps of:
providing a length of cable comprising at least one optical fibre embedded in a solid resin material to form a coated fibre bundle and an extruded polymer sheath covering the coated fibre bundle;
prior to installation in said duct fixing a ferrule sub-assembly on a leading end of the length of cable, the optical ferrule being adapted to become, after installation through said duct, part of a pluggable optical connector for making an optical connection to said at least one optical fibre; and
prior to installation in said duct fixing a restraining part to a portion of said extruded polymer sheath, the restraining part being optionally part of said ferrule sub-assembly, the restraining part being adapted, when said ferrule sub-assembly becomes part of said pluggable connector and when a pull-out force is applied to said pluggable connector by pulling on a trailing portion of the cable, to transfer at least 25 N of said pull-out force to a body of said pluggable connector while any of said pull-out force transferred to said optical fibre remains less than 5 N.

It will be appreciated that, when performing the method of the second aspect of the invention on a commercial scale, a longer length of optical fibre cable may be received, and subdivided into specific lengths for making multiple pre-terminated optical fibre cable assemblies by the method set out.

The invention in the second aspect may include the optional features as set out for the first aspect of the invention, detailed above, in the description of embodiments which follows, and/or in the appended claims.

The invention in a third aspect provides a method of installing a pre-terminated optical fibre cable assembly made according to the first or second aspect of the invention set forth above, the method comprising the steps:
inserting the leading end of said cable including said ferrule sub-assembly into a duct; and
transporting a length of the cable through the duct until a leading portion of the cable protrudes from the duct; and
adding a connector body to the ferrule sub-assembly to complete said pluggable optical connector, at least a part of said connector body engaging with the restraining part for the transfer of said pull-out force.

In some embodiments, the pluggable optical connector is designed to pull out of a compatible adapter or socket with a force less than 30 N, optionally less than 25 N.

In some embodiments, the transporting step is performed by blowing over a distance greater than 100 m. In other embodiments, the transporting step is performed by pushing over a distance greater than 50 m. the cable assembly may be specifically optimised for blowing, for example or for pushing. On the other hand, embodiments of the invention provide cable assemblies which are suitable for installation by choice of methods, including blowing, pushing and/or pulling over substantial distances.

The installation method the third aspect of the invention may further comprise using said pluggable optical connector to connect the at least one optical fibre to supply equipment or to consumer equipment.

The method of installing a pre-terminated optical fibre cable assembly may further comprise connecting one end of the assembly to supply equipment and one end of the pre-terminated optical fibre cable assembly to consumer equipment.

The skilled reader will appreciate that, in a commercial setting, the installation method may be repeated multiple times, to connect multiple premises to one or more distribution points.

The invention in the third aspect may include the optional features as set out for the first aspect of the invention, detailed above, in the description of embodiments which follows, and/or in the appended claims.

The invention in a fourth aspect provides a kit of parts for installing an optical fibre cable, the kit of parts comprising:
a pre-terminated optical fibre cable assembly made according to the first or second aspect of the invention as set forth above; and
a connector body for adding to the ferrule sub-assembly to complete said pluggable optical connector, at least a part of said connector body being adapted to engage with the restraining part of the pre-terminated optical fibre cable assembly for the transfer of said pull-out force.

The skilled reader will appreciate that, in a commercial setting, multiple pre-terminated optical fibre cable assemblies may be provided, with the same and/or different lengths according to a planned installation, each with its respective connector body parts ready for attachment. The connector body parts can be packaged together with each individual length, for ease of deployment.

The invention in the fourth aspect may include the optional features as set out for the first aspect of the invention, detailed above, in the description of embodiments which follows, and/or in the appended claims.

The invention in a fifth aspect provides a kit of parts for use in making a pre-terminated optical fibre cable assembly, the kit of parts comprising:
a length of cable comprising at least one optical fibre embedded in a solid resin material to form a coated fibre bundle and an extruded polymer sheath covering the coated fibre bundle;
at least one ferrule sub-assembly adapted to be arranged on a leading end of the length of cable prior to installation of the cable through a duct, the ferrule sub-assembly being adapted to become, after installation through said duct, part of a pluggable optical connector for making an optical connection to said at least one optical fibre; and
a restraining part which is optionally part of said ferrule sub-assembly, the restraining part being adapted to be fixed to a portion of said extruded polymer sheath prior to installation of the cable through the duct,
wherein said restraining part is adapted, when fixed to said portion of the sheath and when said terminating ferrule becomes part of said pluggable connector and when a pull-out force is applied to said pluggable connector by pulling on a trailing portion of the cable, to transfer at least 25 N of said pull-out force to a body of said pluggable connector while any of said pull-out force transferred to said optical fibre remains less than 5 N.

In some embodiments, the kit of parts according to the fifth aspect of the invention further comprises a connector body for adding to the ferrule sub-assembly to complete said pluggable optical connector, at least a part of said connector body being adapted to engage with said restraining part for the transfer of said pull-out force.

The connector body, which may comprise one or more parts, can be packaged separately, for delivery to an installer after the kit of parts according to the fifth aspect of the invention has been used to make a pre-terminated optical fibre cable assembly according to the first aspect of the invention.

The invention in the fifth aspect may include the optional features as set out for the first aspect of the invention, detailed above, in the description of embodiments which follows, and/or in the appended claims.

The above and other aspects of the invention will be understood by the skilled reader, from the consideration of the following description of exemplary embodiments.

### BRIEF DESCRIPTION OF THE DRAWINGS

Embodiments of the present invention are described below, by way of example only, with reference to the accompanying drawings, in which:

FIG. 1 is a schematic representation of a method of installing Fibre to the Home (FTTH), which includes installing a pre-terminated optical fibre cable assembly according to an embodiment of the present invention;

FIG. 2 is a schematic representation of a blowing process, as an example of how to install a pre-terminated optical fibre cable assembly according to an embodiment of the present invention;

FIG. 3 is a schematic cross-section of a modified fibre unit used in making the pre-terminated optical fibre cable assembly according to one embodiment of the present invention;

FIG. 4 is a schematic representation of a securing a pre-terminated optical fibre cable assembly according to an embodiment of the present invention to the duct after the leading end exits the duct;

FIG. 5 shows an assembled connector formed at the end of a pre-terminated optical fibre cable assembly according to an embodiment of the present invention;

FIG. 6 is an exploded view of the connector of FIG. 5 showing parts of the connector housing, a protective boot, and an end of a pre-terminated optical fibre cable assembly made according to a first embodiment of the present invention;

FIG. 7 shows in more detail part of a pre-terminated optical fibre cable assembly, (a) in the first embodiment (b) in a second embodiment of the invention;

FIGS. 8 (a) to (c) are schematic representations of the stages of assembly of the pre-terminated optical fibre cable assembly the embodiment of FIG. 7(a);

FIG. 9 is a cross-section of the assembled connector of FIG. 5, made using the optical fibre assembly of FIG. 7 (a) according to the first embodiment of the invention;

FIG. 10 is a cross-section of the assembled connector of FIG. 5, made using the optical fibre cable assembly of FIG. 7 (b) according to the second embodiment of the invention;

FIG. 11 shows schematically an apparatus for pull-out testing of optical fibre cable assemblies;

FIG. 12 illustrates a friction test being used for evaluation of a blown fibre cable;

FIG. 13 illustrates a blowing test route used in blowing performance tests;

FIG. 14 shows an accessory for use in pulling installation of a pre-terminated cable assembly;

FIG. 15 illustrates schematically an optical fibre cable assembly pre-terminated at both ends;

FIG. 16 shows in two steps (a) and (b) the installation of the cable assembly of FIG. 15; and

FIG. 17 is a schematic cross section of a further example fibre optic cable according to an embodiment of the present invention, optimised for installation by pushing as well as blowing.

### DETAILED DESCRIPTION OF EXEMPLARY EMBODIMENTS

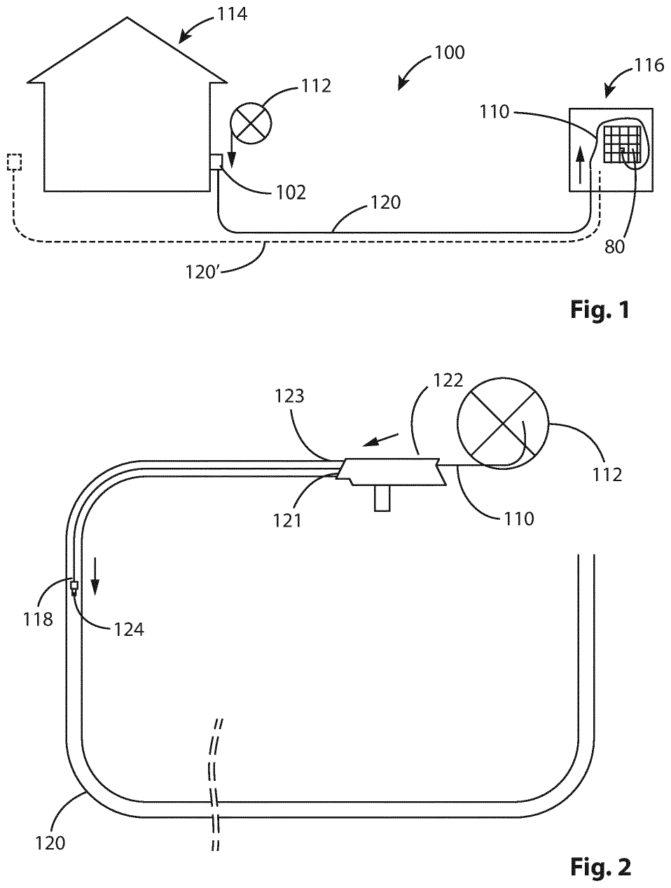

FIGS. 1 and 2 show an example of a Fibre to the Home (FTTH) installation 100 of optical fibres, using a length of fibre unit 110 as a lightweight blowable cable. It will be understood that terms such as “consumer” and “home” are used by way of example only, and the products and techniques described herein may equally be applied in commercial and industrial installations. As will be described in more detail below, one or both ends of the fibre unit has been terminated with a blowable connector component, typically a blowable ferrule sub-assembly 124 including an optical ferrule and a ferrule holder. The optical ferrule is installed on an individual one of the fibres, with the other fibre(s) in the bundle being spare for future use. In the illustrated example, a fibre unit is provided wound on a reel 112 from which pre-terminated optical fibre or fibres are delivered from an access point 102 on the exterior of a building 114, representing the consumer side/home side 114 of the installation 100 to the supply side, for example a telecommunications cabinet 116. Instead of a reel 112, the pre-terminated cable assembly may be provided in other forms, for example in a coil, in a fibre pan etc.

Referring also to FIG. 2, in the illustrated example the FTTH installation 100 is performed by passing a leading end of the fibre unit 110 into a pre-installed duct 120. Other ducts 120′ etc., lead from the same cabinet 116 to other premises, so that this installation method may be repeated many times in a neighbourhood.

FIGS. 1 and 2 show, by way of example, installation by blowing from the consumer side of the installation to the supply side. A leading end 118 of the pre-terminated fibre unit 110 is transported through the duct 120 at least partly by viscous drag created by compressed fluid, for example compressed air. A special blowing machine 122 has a blowing head 121 which is coupled to the receiving end 123 of the duct 120. It will be appreciated that the installation process may also be conducted from the supply side, for example a telecommunication cabinet 116, to the consumer side, according to convenience.

The leading end 118 of the fibre unit 110, which includes ferrule sub-assembly 124, leads the installation of the optical fibre or fibres through the duct 120. The leading end 118 passes through the duct 120 and is fed from the reel 112 until the ferrule sub-assembly 124 and a length of the fibre unit 110 exits the duct 120 within the telecommunications cabinet (see FIG. 1). A protective cap (not shown) may be fitted over the ferrule 124 while the installation takes place. A connector housing (not shown in FIGS. 1 and 2 but described further below) may be added to the ferrule to make a complete connector for plugging into a mating socket or adapter. If desired, the fibre unit can be pre-terminated with the same or different connectors at both ends.

Particular forms of pre-terminated fibre optic cable assembly and methods of installation are disclosed in the earlier patent application WO2018146470A1 (Attorney's reference 11050PWO). The fibre unit in that disclosure is similar to a blown fibre unit disclosed in WO2004015475A2. A protective sleeve is added to the optical fibre before adding an ferrule sub-assembly to the leading end of the optical fibre. The protective sleeve extends for a distance of 1.5 m or so from a point behind the ferrule sub-assembly. When the cable is installed through a duct, the protective sleeve protects the portion of the fibre unit that protrudes from the end of the duct, for example in a communications cabinet. A residual length of the protective sleeve remains within the duct. By clamping the protective sleeve at one end into a connector body and at the other end into the end of the duct, the optical fibres within the fibre unit become protected against damage, where they are vulnerable outside the duct. The protection does not depend on the HDPE sheath of the fibre unit itself as a whole.

As will now be explained, the present disclosure proposes an alternative form of pre-terminated optical fibre cable assembly in which the added blowable sleeve is not required. The construction of the assembly of connector and fibre unit provides sufficient protection against damage and against pull-out forces in particular. Embodiments of this alternative optical fibre cable assembly will be disclosed that include a modified fibre unit. This modified fibre unit and other uses of it are described in another patent application GB 2013892.1 filed 3 Sep. 2020 (attorney's reference 11861PGB) and in a further application having the same filing date as the present application (attorney's reference 11861PGBA). Neither of these applications has been published at the present filing date.

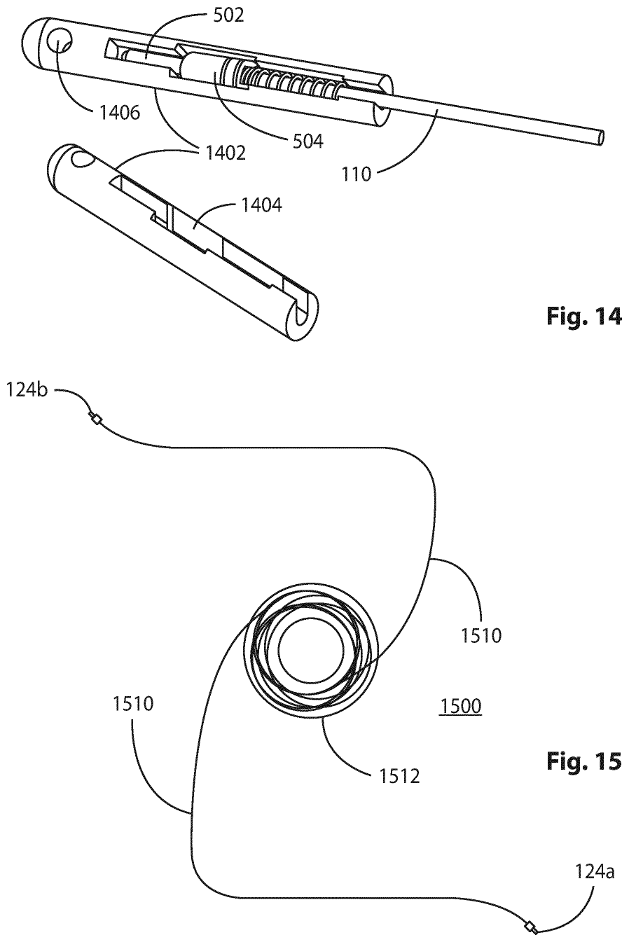

Depending on the situation, including for example the length of connection required, blowing may be the most suitable method of installation. However, the present disclosure is not limited to blowing. An alternative installation process (illustrated later in FIG. 14) involves physically pulling the leading end 118 of the pre-terminated optical fibre cable assembly 110 through the duct 120 via the duct exit 120. For shorter installations, simply pushing the assembly through the duct may be practicable.

A protective cap may be fitted over the optical ferrule while the installation takes place. In an embodiment where pulling is used instead of blowing, an adapter can be applied to provide a pulling eye and to protect the optical ferrule from damage during pulling. One example of such an adapter is described below and is illustrated in FIG. 14.

A fibre catcher (not illustrated) may be used to indicate when the leading end 118 of the optical fibre cable assembly 110 has reached its destination, that is, when the leading end 118 has exited the duct 120 and when a predetermined length of the optical fibre cable assembly 110 is within the cabinet 116. Alternatively, an installer may observe when the leading end 118 exits the duct 120, and communicate with the operator of the blowing machine 122 to cease blowing.

Comparing the example of the present FIGS. 1 and 2 with the disclosure of WO2018146470A1, it may be noted that there is no additional sheath fitted over the end of the fibre unit 23, either before or after installation. According to the principles disclosed in the present application, the nature of the sheath of the fibre unit itself, and the manner of coupling the sheath to the connector, either before or after installation, result in an assembly which is strong enough to protect the fibres, even against forces strong enough to pull out the connector.

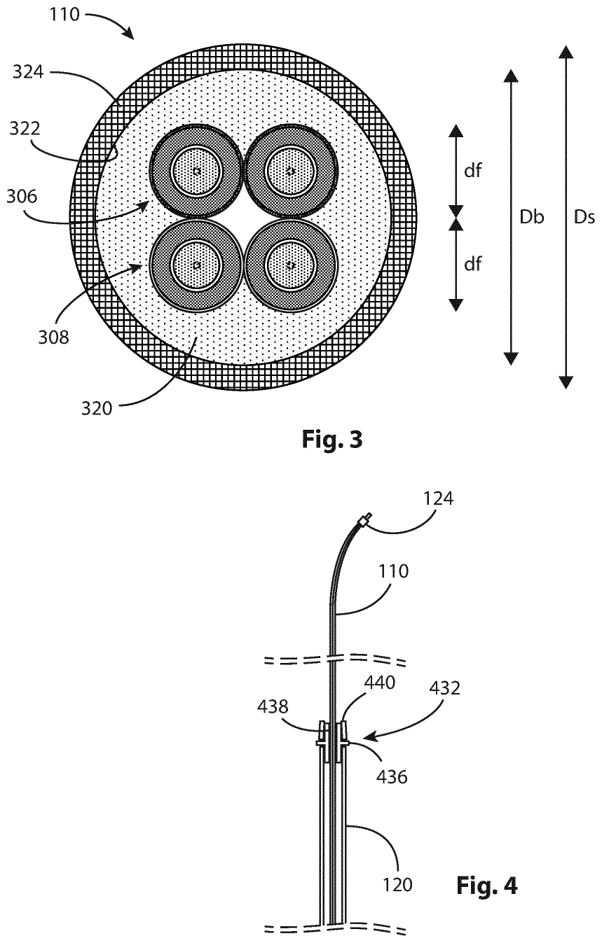

FIG. 3 presents shows in cross section an example of a fibre unit 110 used in the fibre optic cable assembly of FIGS. 1 and 2. The fibre unit 110 in these examples comprises a number of optical fibres 306 (at least one optical fibre) embedded in a solid resin material 320 to form a coated fibre bundle having an outer surface 322. The resin 320 comprises a radiation-cured resin, for example UV cured resin, for example an acrylate. The selected resin has a relatively high glass transition temperature, so that it is not rubbery, but rather solid as it encases the fibres 306 and locks them into a unitary structure. The elastic modulus of the resin material 320 is greater than 100 MPa, for example in the range 300 to 900 MPa, or approximately 300 MPa. Such a resin material 320 has a hardness (modulus) and tensile strength such that the individual optical fibres 306 are locked in a bundle, and substantially prevented from moving relative to one another, and/or relative to the resin material 320. On the other hand, the resin material 320 is not so hard and strong that it cannot be broken away from the fibres 306, when access to the individual fibres 306 is required for termination and/or splicing.

The coated fibre bundle in turn is surrounded by an extruded polymer sheath 324. This type of fibre unit 110 has a structure similar in many respects to a cable assembly of the type disclosed in published international patent application WO2004015475A2. Such fibre units have been designed, and used for many years, for installation by blowing with air or other compressed fluid. Fibre units of this type are known to blow hundreds and even thousands of metres, in microducts having a compatible low-friction lining. However, they can also be installed shorter distances by pulling and/or pushing, depending on the distance and the route involved. The outer sheath 324 is extruded onto the optical fibre bundle during manufacture of the fibre unit, which occurs in advance of manufacture of the optical fibre cable assembly. The outer sheath 324 protects the bundle and facilitates sliding of the bundle through the duct 120. The outer sheath in the known fibre unit for blowing is made of HDPE, with a friction reducing additive and optionally antistatic additives, colour etc.

While the HDPE sheath of the known blown fibre units is relatively thin and hard, relative to other blown designs available prior to WO2004015475A2, the sheath 324 according to the present disclosure may be significantly harder (stiffer) and/or significantly thinner than the sheath of the known fibre units. For example, the known HDPE sheath material may have a tensile modulus on the order of 1000 MPa (for example in the range 700 to 1300 MPa). According to example embodiments presented herein, extruded outer sheath 324 of fibre unit 110 can be based on polybutylene terephthalate polymer (PBT) which has a tensile modulus on the order of 2500 MPa, for example 2600 MPa. Even allowing for some reduction in the modulus caused by the inclusion of additives for reducing friction, imparting colour, antistatic properties and the like, the modulus of the sheath material may still be in excess of 1500 MPa, 2000 MPa, 2200 MPa or 2400 MPa. Likewise, the tensile strength (or tensile stress at yield) of the new sheath material can be significantly higher than that of HDPE. For example, tensile yield stress of HDPE is typically in the mid-20s MPa, while the tensile yield stress of PBT can be 50 MPa or more. The yield stress of the sheath material may be greater than or equal 30 MPa, for example, or 40 MPa or 45 MPa.

For installation by blowing, pushing and/or pulling, sheath 324 according to some embodiments comprises a mixture of polybutylene terephthalate polymer (PBT for short) and additional friction reducing and/or antistatic additives. Suitable commercially available PBT materials include a grades of BASF Ultradur® 6550. Samples described herein have been made using BASF Ultradur® B 6550 LN in particular. Other grades of PBT may be used with suitable adaptation. Other grades of PBT may be used with suitable adaptation. The preferred grade will combine desirable properties for processing, finished product performance and cost. Certain grades may allow a thinner sheath, or easier processing, but at greater cost. For example, BASF Ultradur® B6550LNX is a high viscosity extrusion grade for microtubes in fibre optical cable applications, offering potentially thinner sheath. PBT is of course available from manufacturers other than BASF. The selected PBT material may already contain a certain amount of friction reducing material (“lubricant” in the manufacturer's terminology). As mentioned above though, some embodiments according to the present disclosure are made with additional friction reducing additive. The additional friction reducing additive may comprise a silicon-based lubricant, for example a siloxane such as polydimethylsiloxane-based additive, for example a polyacrylate dimethyl siloxane. A polyacrylate dimethyl siloxane used in the second example is Dow Corning® HMB-1103 Masterbatch, which is available commercially as a “tribology modifier for polar engineered plastics such as polyamide (PA) and polyoxymethylene (POM)”. The amount of polyacrylate dimethyl siloxane may be between 1% and 5% by weight of the material of the extruded sheath, for example 2 or 3%. The amount to be included was determined during set-up tests of the extrusion process of the fibre units. The percentage can be increased in steps starting from 1%, say, until one finds that increasing the amount of additive adds to cost without adding to performance, or causes excessive flowing of the melt during the extrusion process.

Since the selection and proportion of additives has an influence on the extrusion process, it may be that the quantity of additive used may need to be limited to avoid excess flowing of the melt, even if a greater proportion of additive might be beneficial for frictional properties in the finished product. The inventors have found that a further class of siloxane-based additives different to the above-mentioned polyacrylate dimethyl siloxane can be used to obtain friction reduction in the PBT sheath of fibre units, without causing problems in extrusion. An example of this class is Dow Corning® MB 50-002 Masterbatch, which is available commercially as a formulation containing 50% of an ultra-high molecular weight (UHMW) siloxane polymer dispersed in low-density polyethylene (LDPE). It is designed to be used as an additive in polyethylene compatible systems to impart benefits such as processing improvements and modification of surface characteristics, according to the manufacturer's datasheet.

The MB50-002 additive is promoted for (non-polar) plastics such as polyethylene and is based on an LDPE carrier. Conventionally, incompatibility between the PBT and LDPE components would be expected to prevent mixing, leading for example to tearing of the sheath. Surprisingly, such effects are found to be absent when applied in the manufacture of the fibre unit 110, and the additive blends well. One explanation for this may be that the LDPE becomes “momentarily polar” due to oxidisation at the point where the thin tubular film exits the extrusion tip and die. This oxidation creates carboxyl groups, having the effect of making the PE of the masterbatch compatible, in that moment, with the polar polymer such as PBT.

Whatever the cause, the superior performance of the LDPE-based additive MB50-002 is a surprising discovery, since the polyacrylate dimethyl siloxane additive HMB-1103 is the one promoted by the manufacturer for use in polar plastics, including PBT. The same may be expected for PDMS additives promoted by other manufacturers.

As for the previous example, the amount of LDPE additives additive to be included can be determined during set-up tests of the extrusion process of the fibre units. The percentage can be increased in steps starting from 1%, say, until one finds that increasing the amount of additive adds to cost without adding to performance, or causes excessive flowing of the melt during the extrusion process. The amount of additive may be between 1% and 5% by weight of the material of the extruded sheath, for example between 2 and 4%, more particularly between 2.5 and 3.5%. A value of 3% has been found suitable, bringing further enhancement in friction performance, without extrusion problems. The masterbatch MB50-002 has a loading of PDMS of 50%, which may be high compared with the (unknown) percentage in the HMB-1103. Based on the value of 50% and the inclusion of 3% of the additive as a whole, it will be seen that the overall siloxane content of the sheath material is around 1.5%, i.e. greater than 1%. For the purpose of the following examples and the reported testing, it is the PBT material with 3% masterbatch MB50-002 that will be used.

Having said that, PBT is not the only polymer that may be used as a base for the polymer sheath 324, and other polymers may offer the required the mechanical performance when combined with a coated fibre bundle and suitable termination components. As a further modification, the polymer sheath 324 in these examples may also be fully or partially cross-linked, for example to modify mechanical properties such as modulus (stiffness) and strength (yield stress), to improve dimensional stability and/or to improve high temperature performance. Other additives such as fillers, colouring, anti-static and the like may also be included.

By suitable control of the extrusion process, and selection of materials, the extruded outer sheath 324 can be prevented from bonding to the coated fibre bundle. This allows it to be cut and removed without damaging the outer surface 322 of the resin material, when stripping the fibre unit to access the individual fibres. Whereas the sheath of WO2004015475A2 is designed to be relatively loose so as to slide off the coated fibre bundle in long sections, the sheath of the modified fibre unit 110 can be relatively close-fitting, even tight. Suitable tools can be provided for making a longitudinal cut, so that the outer sheath can be split open and peeled off longitudinally, rather than being removed by sliding.

Various dimensions of the fibre unit and its components can be envisaged. The number of fibres 306 in a design such as shown in FIG. 3 can vary from as few as two to 4, 6, 8, 12 or even 24 fibres, similar to the applicant's existing range of blown fibre units. In the example illustrated, four optical fibres 306 are included in the resin bundle 320. These may be four signal-carrying fibres. Alternatively, the pair of fibres 308 shown with no colour in their outer coating layer may be “dummy” or “mechanical” optical fibres 308 which are included in the resin bundle only to provide mechanical stiffness and symmetry. This is a feature known from existing blown fibre units, and it is expected that this particular fibre unit may be better adapted for blown installation than one having only two fibres in total.

In one example, assuming that the diameter df of the four primary coated fibres is approximately 0.25 mm each, the diameter Db of the coated fibre bundle is for example 0.80-0.82 mm, and the diameter Ds of the product including the sheath 324 may be around 1.2 mm. The thickness of the sheath is accordingly about 0.2 mm, or a little under. The sheath 324 in this example is of PBT with a siloxane additive, for example an ultra-high molecular weight siloxane in an LDPE carrier, such as the one mentioned above.

A single such fibre unit, without being encased in any other structure, is found to be suitable for use as a fibre optic cable suitable for installation in microducts by means of blowing. As is known for the known blown fibre unit (WO2004015475A), the embedding of the optical fibres in a relatively solid resin provides a stiffness to the structure of the fibre unit, independent of the stiffness of the outer sheath. With the increased strength, hardness and stiffness of the PBT material relative to HDPE, a fibre unit better suited to pushing and pulling can be provided. Additionally, a fibre well suited to installation by blowing can be provided. The thickness and detailed composition of the PBT or other sheath material can be adjusted and optimised for one particular installation method. To favour blowing, a thinner sheath can be provided, which is nevertheless a robust protection for the fibres contained within, and does not interfere with blowing performance.

In a specific example designed for blowing, dimensions are as shown approximately to scale in FIG. 3, the diameter Db of the coated fibre bundle is again 0.80-0.82 mm, but the diameter Ds of the product including the sheath 324 is around 1.05 mm. The thickness of the sheath is accordingly about 0.115 mm, somewhat thinner than in the examples of the prior art. The sheath 324′ in this example is of PBT with a siloxane additive, for example an ultra-high molecular weight siloxane in an LDPE carrier, such as the one mentioned above. Thanks to the inherent stiffness and strength of the PBT-based material, as well as the very low friction properties of the material, the sheath can have a thickness substantially less than 0.2 mm, for example less than 0.15 mm or less than 0.13 mm. Thickness in the range 0.05 to 0.25 mm can be envisaged. On the other hand, (as mentioned already above) a single design of fibre unit can have a degree of performance in pushing, pulling and blowing.

It will be understood that the above are not the only designs of fibre optic cable that are possible within the scope of the present disclosure. A fourth example is described below, with reference to FIG. 19, in which one or more additional strength members are included within the coated fibre bundle. The number of optical fibres in such a design can vary from as few as one upwards.

With reference now to FIG. 4, after the leading end 118 of the fibre unit 110 exits the duct 120, installation at the telecommunications cabinet 116 is completed by plugging the open end of the duct 120 with a suitable accessory.

In the illustrated example, the duct 120 is plugged with a plug accessory connector 432 that has an outer diameter that is configured to be a push-fit into the duct 120 and has a hollow or groove into which the fibre unit containing the optical fibres is received. A flange 436 is provided as a stop and/or seal on the outside of the connector 432. The flange 436 is operable to cap the exit of the duct 120.

In the illustrated example, an exposed extension member 438 of the plug accessory 432 extends beyond the flange 436 and envelops part of the fibre unit 110. A capping sleeve 440 may be added to the exposed extension member 438. The capping sleeve 440 is operable to locally compress the plug accessory 432 against the fibre unit sheath to prevent fibre unit movement after installation of the optical fibre cable assembly.

FIG. 5 illustrates in more detail one example of a connector 500 that may be used at the leading end of the pre-terminated optical fibre cable assembly 110. Visible at the right hand end is the tip of a ferrule sub-assembly 124. The ferrule sub-assembly 124 is of a size suitable for installation through the duct 120, and does not form a complete connector assembly 500 until other components are added. In the illustrated example, the connector body is made according to principles disclosed in published United Kingdom patent application GB2589365A. This type of connector defines a limit to the pull-out force required to remove the connector from a socket. The connector 500 illustrated in FIG. 5 is designed to mate with another LC connector in a standard LC type adapter. (In effect, the fitting one connector in the adapter forms a socket for the mating connector to plug into. The terms “socket” and “adapter” may therefore be used interchangeably for the purposes of the present disclosure, except where the context requires otherwise.) The conventional LC connector, however, is designed to snap-lock and not withdraw until the latch is released by deliberate user actuation. The LC connector is the most common type for use in a congested setting like the street cabinet 116 of FIG. 1, for example. Consequently, it is also a common hazard that installed cables are liable to be pulled accidentally and damaged by destructive forces.

The connector 500 comprises, in addition to ferrule sub-assembly 124, a connector rear body 502, a connector front body 504 and a flexible boot 506 from which the fibre unit 110 emerges. These parts, which will be described in more detail below, are locked together to form a connector body 508. A latch mechanism 510 comprises a pair of resiliently deformable latch members 521, 522 which extend from a common point on the top side of connector body 508 and extend rearwardly beyond the edge of the front body 504, parallel to a longitudinal axis of the connector and cable. The latch members 521, 522 are mirror images of each other along the longitudinal centre line of the connector and are shaped to extend slightly away from one another, forming a V shape on the top of the connector body 140. The latch members 521, 522 are offset from the body 508 of the connector, such that there is a gap between the top surface of the body 508 and the underside of the latch members 521,522.

As described in more detail in GB2589365A, when the connector body is latched into a corresponding adapter (not shown here), the connector can be unlatched by a user pinching together the latch members 521, 522 in an inward direction toward one another, so allowing the withdrawal of the connector 500 from the adapter. Additionally, however, engaging surfaces of the latch members 521, 522 are shaped with a kind of cam profile which will push the latch members toward one another without user actuation. In this way, a sufficient a force applied in a direction parallel to the longitudinal axis of the connector 500 will also allow unlatching and withdrawal of the connector 500 from the adapter. A force of 20 N or above may overcome the resilient bias of the latch mechanism 510 and remove the connector 500 from the adapter 110. Using the connector of GB2589365A, therefore, the risk of permanent deformation or failure of the connector or cable when large forces act upon the connector, such as accidental forces, is greatly reduced. The connector 120 is removed from the adapter 110 at 20 N and as such the connector 500 will never experience the full force that a conventional latch mechanism can transmit.

GB2589365A proposes a minimum removal force of between 15N and 30N is required to overcome the resilient bias to remove the fibre optic connector from a fibre optic adapter, with a removal force of 20N being a preferred threshold required to overcome the resilient bias to remove the fibre optic connector from a fibre optic adapter. LC is only one type of connector, of course. Another common type of connector is the larger SC (subscriber connector) type connector, which may also be designed to pull out with a force lower low enough to ensure no damage between the optical fibres and the ferrule. The pull-out force of the modified SC connector may be for example about 20 N, with a maximum of 25 N, say. Conventionally, an SC type connector might be provided on the premises end of the cable, but it is also becoming common for the smaller LC connectors to be used at both ends.

Whatever type of connector is used, the fixing of the cable within the connector needs to protect the optical fibres from being subjected to any tensile force greater than 5 N, or the connection may be destroyed. This is the reason why most pluggable cables have reinforcing yarns of aramid (Kevlar®) or the like which can be anchored to the connector body, and why the blown fibre unit of WO2018146470A1 has the additional sleeve to protect the length of fibre unit between the connector and the duct.

FIG. 6 illustrates a fibre optic cable assembly 600 including a blowable fibre unit 110 of the type illustrated in FIG. 3 and a ferrule sub-assembly 124 coupled to one optical fibre 306 of the fibre unit 110. After installation through a duct 120, the assembly is combined with the connector rear body 502, connector front body 504 and boot 506 to form a cable with connector as seen in FIG. 5. As will be explained, the construction of the assembly exploits the superior mechanical properties of the sheath 324 to protect the fibres against undue forces without the provision of strengthening yarns or added sleeves.

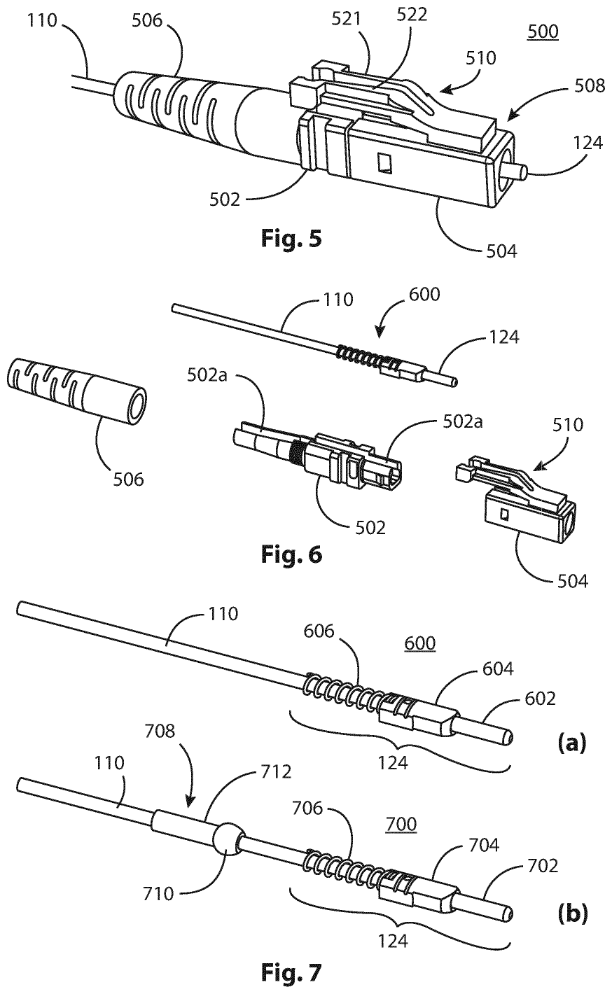

As seen enlarged in FIG. 7(a), the ferrule sub-assembly 124 in this example comprises a generally cylindrical optical ferrule 602 supported by a ferrule holder 604 and a spring 606. Ferrule holder 604 is shaped with keying surfaces to ensure accurate alignment of the optical ferrule 602 with the connector axis, where it will mate with a complementary ferrule in the socket. As is known, the end surface of the optical ferrule, with the optical fibre embedded in it, can be ground and polished either flat or at an angle. The spring 606 is for biasing the optical ferrule into engagement with the optical ferrule of a mating connector to ensure a good connection. In principle, only one of the connectors needs to have the spring biasing, while the other one could be rigid. In practice, design and manufacturing tolerances will be greater when a spring is provided, and the inclusion of a spring avoids any concern that a mating connector might be rigid.

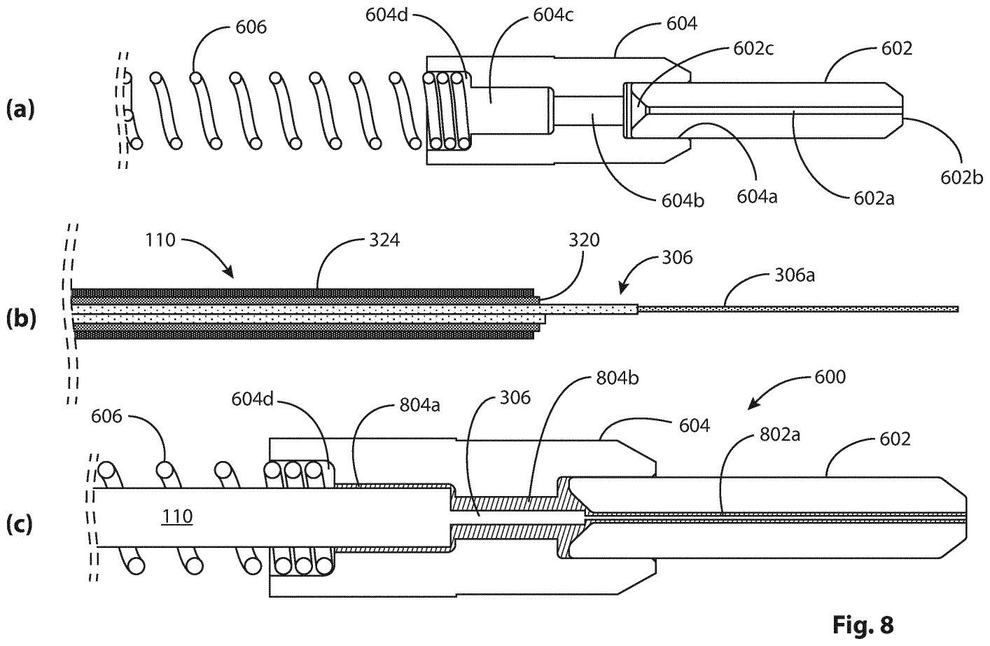

It will be understood that, while the cable may carry more than one optical fibre, for example 2 or 4 optical fibres, in the majority of installations, only one of these fibres carries live signals, and only that one is provided with a ferrule sub-assembly 124. The unused fibres are used, when necessary, as backup. In the assembly 600, a selected one of the optical fibres 306 is inserted into the bore of the optical ferrule 602 and cemented there using, for example, an epoxy resin. So much is common to all optical ferrule connectors. However, in the modified optical fibre cable assembly 600, not only an optical fibre but also a portion of the outer sheath 324 is fixed in the optical ferrule and/or the ferrule holder 604, again with epoxy resin or another adhesive. In this way, ferrule holder 604 is made to serve also as a restraining part for transferring tensile forces from the trailing cable 110 to the connector body, after installation. This process will be illustrated in more detail with reference to FIG. 8.

FIG. 7(b) illustrates an optical fibre cable assembly 700 according to a second embodiment of the disclosure. In the assembly 700, a selected one of the optical fibres 306 is inserted into the bore of the optical ferrule 702 and cemented there in the conventional fashion. Optionally a portion of the outer sheath 324 is fixed in the optical ferrule and/or the ferrule holder 604, as in the case of the assembly 600. Additionally, however, an eyelet 708 having a bulbous head 710 and a cylindrical body 712 is provided to the rear of the optical ferrule and spring 706, and this eyelet is bonded to the material of the sheath 324. The bulbous head 710 acts as an annular projection for use in restraining the axial movement of the fibre unit. The rounded form of the head 710 of the eyelet is designed not to catch on any edges or joints, as the assembly progresses through a duct. The external design of eyelet 708 shown in these examples is one that exists already for use in the known fibre cable assembly. The inner bore of eyelet 708 is adapted to the outer diameter of the particular fibre unit 110. In this embodiment, eyelet 708 is made to serve as a restraining part for transferring tensile forces from the trailing cable 110 to the connector body, after installation. Other designs of restraining part course can be used. Being rounded at both front and back, the bulbous head 710 is intended to allow rearward retraction of the cable, as well as forward installation.

For the purposes of the present description, it will be assumed that there is only one active fibre 306, and only one ferrule sub-assembly 124, 602, 702 etc., However, it is not excluded that two or more optical ferrules (not illustrated) can be simultaneously connected to two or more individual optical fibres within the cable assembly. In one specific example, known from GB2509532A, each ferrule holder 604 is D-shaped in cross-section. The flat portions of the D-shaped bodies are abutted such that the combined dimension of the abutted bodies is small enough so both ferrule bodies can pass together through a duct when nestled side-by-side in a suitable caddy. Other duplex and multiplex connectors are known which can be adapted also for use in cable assemblies according to the present invention. For example, dual ferrules can also be arranged longitudinally staggered for installation. The flat portions of the D shape in the illustrated examples provide for precise location and orientation of the fibre in the connector body, regardless whether the option to terminate two fibres is exploited.

Turning to FIG. 8, an assembly method for the optical fibre cable assembly 600 is illustrated in three steps (a), (b) and (c). At (a) there is illustrated in enlarged schematic cross-section the parts of the assembly excluding the fibre unit 110, namely the optical ferrule 602, the ferrule holder 604, and the spring 606. Optical ferrule 602 has the bore 602a extending from a front optical face 602b all the way to a tapered opening 602c at the rear. Ferrule holder 604 has, in order from front to rear, a first cavity portion 604a for receiving the rear end of optical ferrule 602, a second cavity portion 604b for the active optical fibre, slightly larger third cavity portion 604c for receiving a short length of fibre unit 110 including sheath 324 and finally the fourth cavity portion 604d for receiving a forward end of spring 606, as shown.

Dimensions of these components are relatively small. The standard LC optical ferrule 602 has a diameter of 1.25 mm, and the first cavity portion 604a is sized to hold the optical ferrule tightly with high positional accuracy and alignment. Ferrule holder 604 may be for example a metal part. Second cavity portion 604b is narrower, and may have a length for example 2 mm. The third cavity portion 604c is sized to accommodate the outer diameter of the fibre unit, which in these examples is nominally 1.05 mm, and may have a length for example 3 mm. In the tests presented below, some samples have a third cavity portion 604c with diameter 1.05 mm, and other samples have 1/3 cavity portion 604c with diameter 1.1 mm.

Referring to FIGS. 8(b) and (c) the steps of preparing the leading end 118 of fibre unit 110, and fixing it in the optical ferrule will now be described. Detail of the prepared end of the fibre unit 110 is shown at (b), while, for simplicity, it is shown only in outline FIG. 8(c). The steps of preparing and assembling are as follows:
1. Carefully strip the PBT sheath 324 from a length of the coated fibre bundle and peel the acrylate resin layer 320 back flush to the same point as closely as possible.
2. Cut off the unused optical fibres leaving just one active fibre 306 to terminate.
3. Strip the acrylate coating from a length of the active fibre leaving only the exposed glass 306a with a length in excess of the bore 602a of the optical ferrule.
4. Thoroughly clean the cable jacket and fibre using suitable fluids and equipment.
5. Terminate the fibre into the ferrule ensuring the ferrule is fully seated and ensuring there is epoxy resin 802a over the exposed glass fibre within the bore 602a of the optical ferrule, epoxy resin 804b within the second cavity portion 604b surrounding the remaining exposed length of active fibre 306, and within the third cavity portion 604c surrounding a length of the sheath contained. Care is taken not to overfill and glue the spring 606 to the ferrule holder 604.
6. Cure the assembly at a raised temperature, for example 120° C. for 20 minutes.
7. Cleave the fibre, then polish the optical face. This step can be performed with the ferrule sub-assembly mounted in a connector body or in a jig equivalent to the connector body, to ensure proper alignment.
8. The fibre is then tested for insertion & return loss, end face and geometry testing to ensure that it meets the required standards and specific customer requirements.

On completion of the steps, the optical fibre cable assembly 110 is then ready for installing by blowing, pushing or pulling as described above with reference to FIGS. 1 and 2.

In the case of the second embodiment (optical fibre cable assembly 700), the same steps may be applied, except that the eyelet 708 is first slid over the sheath and bonded by epoxy to the sheath 324 in advance of preparing the leading end for fitting into the ferrule and ferrule holder. Of course, the selected active fibre 306 will still be set with epoxy into the bore 602a of optical ferrule 602, and the cavities 604b and 604c can also filled with epoxy in the second embodiment.

In principle, other means of fixing these components together may be deployed, aside from cured epoxy resin. Other types of adhesive may be deployed, and/or mechanical coupling such as by ridges, crimping or the like. These include the so-called “field-installable” or “field fit” connectors, which use refractive index-matching gel rather than epoxy resin in the bore of the optical ferrule 602. Such mechanical coupling can engage the coated fibre, the resin bundle and/or the sheath 324. In the illustrated examples, however, the use of a cured epoxy resin is convenient and avoids the risk of mechanical damage and/or micro-bending losses.

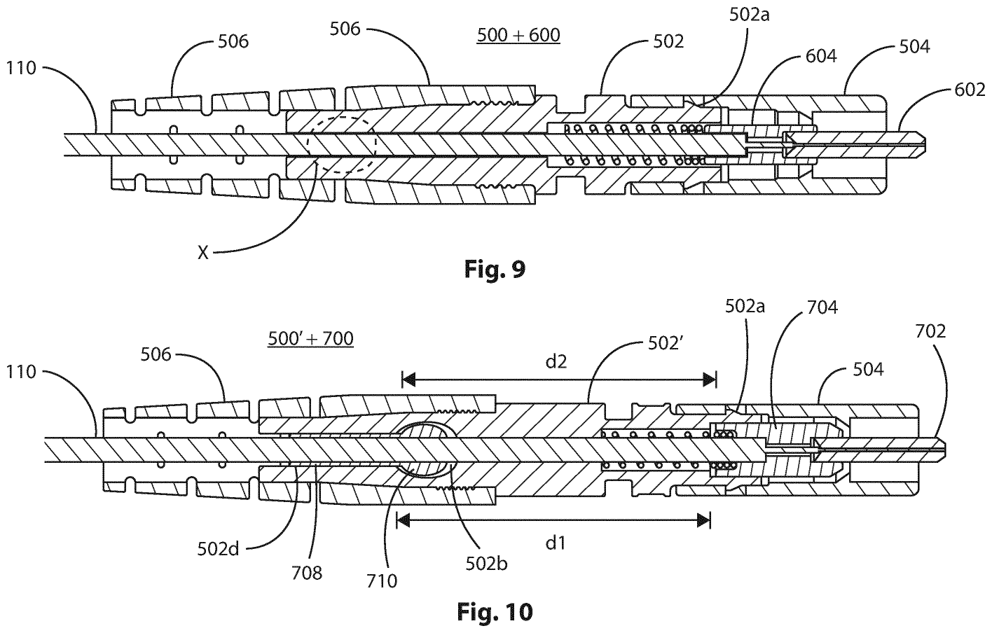

Referring to FIGS. 9 and 10, after the leading end 118 of the optical fibre cable assembly 600 or 700 emerges from the duct 20, a connector body is fitted over the ferrule sub-assembly 124. In the illustrated examples, and recalling FIGS. 5 and 6, the connector body includes a rear body 502, a front body 504 and a boot 506, fitted over the fibre unit 110 and ferrule sub-assembly 124 in a particular sequence, to complete construction of the optical fibre cable assembly 110 with connector 500 suitable for connecting within the telecommunications cabinet 16. The boot 506 may be of a deformable material and deformable construction, compared with the other parts of the connector body.

FIG. 9 shows a cross-section of the optical fibre cable assembly 600 assembled with the connector parts. To reach this completed assembly, the boot 506 has been slid over the optical ferrule 602 and ferrule holder 604 and springs 606 as a preliminary step. Next the rear connector body 502 has been fitted to the optical ferrule and ferrule holder and spring, by means of its open slot 502a, which is visible in the perspective view of FIG. 6. Next, front body 504 is slid over the front of the body and the projecting optical ferrule 602, whereupon it snaps into engagement with 502a projections on the rear body 502. Finally, the boot 506 is slid up to engage with the rear body, these parts having a push fit and/or mating screw threads to join them together. In a convenient example, the material of boot 506 is sufficiently deformable that the boot can simply be pushed on, while the screw thread allows it to be removed in case of need.

At the conclusion of the steps, the connector is complete as shown in longitudinal cross section in FIG. 9. Mating surfaces of the ferrule holder 604 and connector rear body 502 ensure that the optical ferrule 602 including the end of the active optical fibre 306, are properly aligned for mating with a receiving connector in the usual manner. Notice that the leading end of the fibre unit 110, including the sheath 324 of PBT or similar material, is mechanically joined by epoxy to the ferrule holder 604, in addition to the glass optical fibre portion 306a being cemented in the usual manner within the optical ferrule 602. The inventors have found that, even in this short few millimetres, the strength of the bonding, as well as the stiffness and strength of the sheath 324 itself, is more than sufficient to protect the optical fibre 306 against tensile forces, to a limit substantially greater than the pull-out force which will cause disengagement of the modified LC connector 500, or of a conventional SC connector. No additional sleeve is required to be fitted, either before or after installation. That is to say, if one pulls the fibre unit 110 while holding the connector 500, the fibre unit sheath and the epoxy bond will endure tensile forces substantially greater than 20 N, without the optical fibre itself being subjected to a force greater than 5 N.

FIG. 10 is a similar cross-section of a connector 500′ assembled around the leading end of an optical fibre cable assembly 700 having the features described above with reference to FIG. 7(b), including the eyelet 708 with bulbous end 710. The parts are substantially the same in FIG. 10 as in FIG. 9, and like reference signs indicate corresponding parts. The principal difference between the two embodiments is that the rear body 502′ of connector 500′ includes a cavity 502b′ for receiving the bulbous head 710 of the eyelet 708, and a cavity 502c′ for receiving the cylindrical body 712 of the eyelet. Eyelet 708 is adhered by epoxy or suitable adhesive or other mechanical coupling to the outside of the sheath 324 that is to say, eyelet 708 cannot move in the longitudinal direction relative to the fibre unit 110 and the optical fibres that it contains. On the other hand, eyelet 708 is free to slide within its cavity in the rear body 502′. The limits of this sliding are defined by the length of cavity 502b′, which allows a fraction of a millimetre displacement, before abutting the rear end of the cavity. This abutment defines the load bearing point when a tensile load is applied to the trailing fibre unit 110. Again, by virtue of the fixing of the eyelet to the sheath, and the entrapment of the eyelet within the rear body 502′ of the connector, tensile loads are applied to the sheath, and the optical fibre itself is protected against any forces that would impair optical performance and risk permanent damage.

The first embodiment, as exemplified by FIG. 9, has the attraction of simplicity, fewer parts and relative ease of manufacture. On the other hand, its protection against pull-out forces depends on the few millimetres of sheath 324 being bonded to the ferrule holder 604. The assembly 700 of FIG. 10 may be considered stronger in view of the greater length for bonding to the sheath 324 within the eyelet 708. On the other hand, the design and manufacture of assembly 700 requires much tighter tolerances, in order to protect the optical fibre against damage in use. Specifically, the distance d1 between the rear of the ferrule holder 704 and the rear of the bulbous head 710 of the eyelet 708 should be very slightly greater than the distance d2 between the part of the connector rear body 502′ where the rear of the ferrule holder 704 abuts, and the rear of the cavity 502b where the rear of the eyelet head 710 abuts. In this way, it can be ensured that tensile load comes to bear upon the eyelet 708 and sheath 324, rather than on the optical fibre 306 and optical ferrule 702. At the same time, the eyelet head 710 is biased (by the spring 606 acting through the ferrule holder adhered to the fibre unit) to sit forward within the cavity 502b when the connector is un-mated and should have sufficient movement to allow the optical ferrule 702 to retract against the spring action without unduly compressing the optical fibre, when the connector is mated or when the optical ferrule is subjected to an accidental “bounce” test. The requirements can be met by careful design and manufacture, but the tolerances involved are fractions of a millimetre.

An optional use of the first embodiment involves epoxy resin or other means being used to fix the sheath 324 of fibre unit 110 within the bore of the connector rear body 502 in the region indicated ‘X’ in FIG. 9. As in the case of the second embodiment, the extended length for bonding may allow a stronger connection, but the optical fibre between this point of connection and the movable optical ferrule becomes vulnerable to compressive forces, potentially causing micro-bending losses, if not actual damage to the fibre. In addition, of course, the bonding at region X cannot be done without the connector rear body 502 being present. It is therefore not a feature of the pre-terminated blowable cable assembly, but rather a feature of the finished installation.

Further embodiments can be envisaged, including connectors in which the spring 606/706 is omitted and the problems of compressing the optical fibre are avoided or at least reduced. If the spring is omitted in standard connectors like LC and SC, this would require assurance that sufficient spring action will be provided in the mating connector.

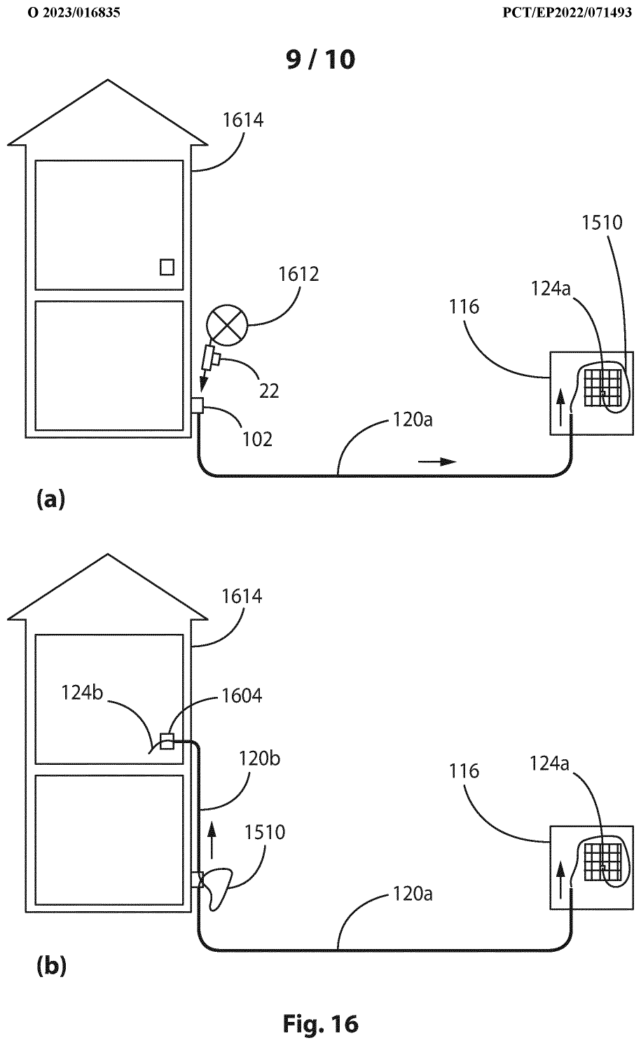

If desired, the process illustrated in FIG. 8 can be repeated at the opposite end of the optical fibre, to create a double pre-terminated cable assembly (described below with reference to FIGS. 15 and 16). The connectors at both ends do not need to be the same. In current practice, an SC connector is commonly used to terminate the optical fibre at the consumer premises. The SC connector ferrule and connector body of larger than those of the LC connector, but the same principles can be applied to protect the fibres against accidental pull-out forces. In other embodiments of the present disclosure, the more compact LC type connector is used at both ends. The ferrule sub-assembly 124 of the LC connector can be smaller, and compatible with the smallest micro-ducts used for blowing. Ferrule bodies having the D-shaped profile mentioned above can of course be used in installations where only a single fibre is terminated, as shown here, as well as installations where a pair of fibres are terminated and the two ferrule sub-assemblies travel together during installation in a duct. Even with the same connector type at both ends, the different embodiments described above can be mixed at opposite ends of the same cable. For example, a spring action may be required at one end but not the other. A stronger retention force may be required at one end than at the other end.

### Retention (Pull-Out) Tests and Test Results

As mentioned above, all of the following tests are performed on fibre unit 110 made using BASF Ultradur® B 6550 LN for the base polymer of the sheath 324. As friction reducing additive, Dow Corning masterbatch MB50-002 is included in the material at 3% by weight.

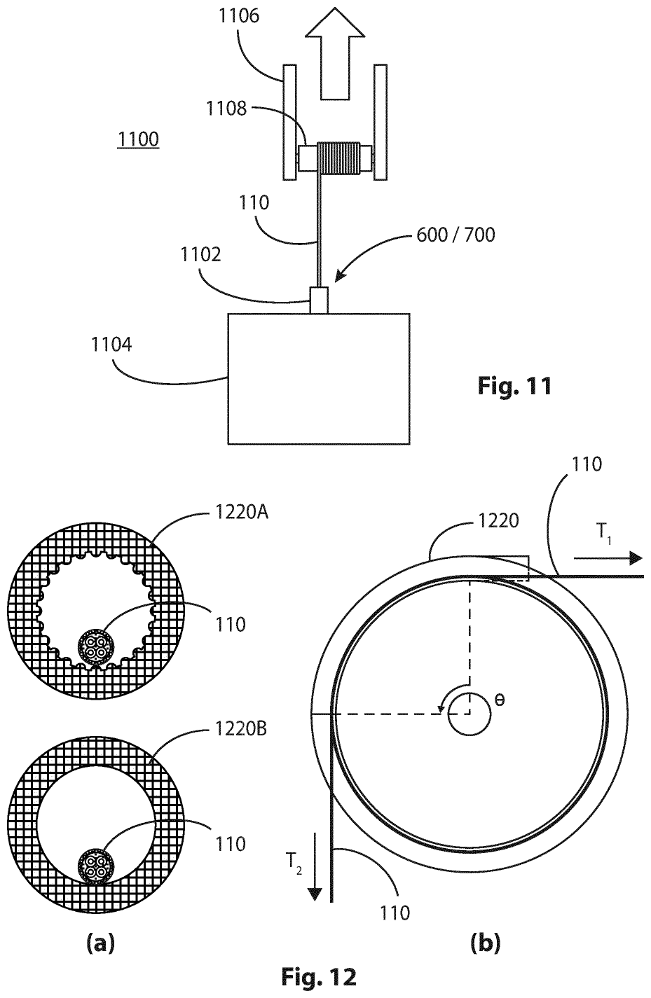

FIG. 11 shows a testing setup 1100 for using a tensometer confirming whether an optical fibre cable assembly such as the examples 600 and 700 described above has a tensile strength (pull out strength) sufficient to protect the optical fibres in the manner described above. The skilled person will be familiar with tensometer and their application in tensile testing of materials and assemblies. In the lower part of the apparatus, a vice 1102 is mounted on a base 1104. Moving carriage 1106 is coupled to a computer-controlled drive mechanism (not shown) via a load cell (also not shown) for measuring tensile force. For the present task, the carriage 1106 is provided with a cylindrical mandrel 1108 around which a length of fibre unit 110 can be wrapped provide a secure connection.

For testing the fibre optic cable assembly 600, as an example, ferrule holder 604 can be held in the vice. Alternatively, the connector rear body 502 or an assembled connector 500 can be fitted around the assembly at the end of the fibre unit, and held in the vice. Likewise, for testing the fibre optic cable assembly 700, as another example, the eyelet 708 can be held in the vice. Alternatively, the connector rear body 502′ of an assembled connector 500′ can be fitted around the assembly at the end of the fibre unit, and held in the vice.

In one test, four samples of fibre unit were prepared with termination at both ends of each length, using the structure and method of the first embodiment (optical fibre cable assembly 600 assembled as shown in FIG. 8(c)). At one end of each sample (end A), the ferrule holder 604 was formed with cavity 604c having an inner diameter of 1.05 mm, matching exactly the outer diameter of the fibre unit 110. At the other end of each sample (end B), the ferrule holder 604 was formed with cavity 604c having an inner diameter of 1.10 mm, slightly larger than fibre unit, thereby allowing more space for epoxy adhesive. Eight tests were then performed, using the tensometer setup shown in FIG. 11 to apply increasing upward force on the mandrel until the connection between the fibre unit and the ferrule holder breaks. The results are shown in Table 1.

TABLE 1
Retention force of fibre unit in ferrule holder 604

| | | RETENTION |
|---|---|---|
| Sample | CAVITY ID | FORCE (N)(N |
| 1 End A | 1.05 mm | 42.25 |
| 2 End A | 1.05 mm | 49.7 |
| 3 End A | 1.05 mm | 48.31 |
| 4 End A | 1.05 mm | 46.25 |
| 1 End B | 1.10 mm | 50.63 |
| 2 End B | 1.10 mm | 37.51 |
| 3 End B | 1.10 mm | 48.72 |
| 4 End B | 1.10 mm | 40.99 |

| | |
|---|---|
| Average | 45.545 |

The retention force in all samples was above 35 N, with an average above 45 N. This confirms that, only bonding to the ferrule holder in the manner of the first embodiment, a retention force far in excess of 20 N can be achieved. Consequently, when terminating such a fibre optic cable assembly 600 into a connector having a designed retention limit of 20 N, the construction and the material of the fibre unit sheath 324 are clearly sufficient to protect the optical fibres from undue tension, even in the case of accidental pull-out. If there was any difference between the ferrule holders with different inner diameters, the more close-fitting diameter used at end A seems to provide at least the same if not better retention.

### Connector Optical Performance Tests and Test Results

Various further tests have been performed on samples of the optical fibre cable assemblies described above, to confirm successful optical performance. A test procedure to confirm correct optical performance, and especially to check for micro-bending losses caused by compression of the fibre within the connector, was as follows:
1. Terminate the optical fibre as illustrated in FIG. 8, 9 or 10 and optically test the assembly using a standard LC Test Lead. “Optical performance” in this context means acceptable insertion loss and return loss, unless otherwise noted.
2. In a case with the optional adhesive at in the region X, secure the fibre unit at the back of the rear body using adhesive. (This can be done with the connector front body 504 fitted, to ensure correct positioning of the components.) Allow epoxy to fully cure before testing.
3. Couple the test sample to a test lead such that the ferrule displaces against the spring and optically re-test the assembly against the standard LC Test Lead
4. Perform repeated mating tests (for example 10 times)
5. Perform Random testing
6. Fit a connector front body and perform “snatch” testing to measure both the tensile load and insertion loss. This snatch testing simulates the accidental pull-out of cables and connectors.

Table 2 shows optical performance tests without fixing the fibre unit sheath to the rear body 502, in accordance with the first embodiment of FIG. 9.

TABLE 2
(Insertion loss (first embodiment))

| Sample ID | 1310 nm | 1550 nm |
|---|---|---|
| 1.05 mm 03A | 0.04 dB | 0.04 dB |
| 1.05 mm 03B | 0.08 dB | 0.11 dB |
| 1.05 mm 04A | 0.05 dB | 0.06 dB |
| 1.05 mm 04B | 0.05 dB | 0.09 dB |
| 1.10 mm 03A | 0.14 dB | 0.14 dB |
| 1.10 mm 03B | 0.04 dB | 0.05 dB |
| 1.10 mm 04A | 0.02 dB | 0.05 dB |
| 1.10 mm 04B | 0.04 dB | 0.05 dB |

Table 3 shows optical performance tests after fixing the fibre unit sheath to the rear body 502 in the region X, according to the optional installation method mentioned above.

TABLE 3
Insertion loss (with optional bonding)

| Sample ID | 1310 nm | 1550 nm |
|---|---|---|
| 1.05 mm 03A | 0.03 dB | 0.07 dB |
| 1.05 mm 03B | 0.08 dB | 0.12 dB |
| 1.05 mm 04A | 0.04 dB | 0.07 dB |
| 1.05 mm 04B | 0.07 dB | 0.10 dB |
| 1.10 mm 03A | 0.31 dB | 0.28 dB |
| 1.10 mm 03B | 0.07 dB | 0.05 dB |
| 1.10 mm 04A | 0.06 dB | 0.07 dB |
| 1.10 mm 04B | 0.04 dB | 0.06 dB |

5 After fixing the Fibre Element at the rear of the LCv rear body and retesting it can be seen that there was little effect on the measured insertion loss. This may be due in part to the majority of the displacement taking place in the mating LC connector.

Table 4 shows optical performance during repeated mating after fixing the fibre unit sheath to the rear body 502.

TABLE 4
Repeated insertion (with optional bonding)

| | 1st | 1st | 10th | 10th |
|---|---|---|---|---|
| Sample | 1310 nm | 1550 nm | 1310 nm | 1550 nm |
| 1.05 mm 03A | 0.05 dB | 0.04 dB | 0.02 dB | 0.05 dB |
| 1.05 mm 03B | 0.06 dB | 0.09 dB | 0.05 dB | 0.09 dB |
| 1.05 mm 04A | 0.06 dB | 0.07 dB | 0.04 dB | 0.06 dB |
| 1.05 mm 04B | 0.05 dB | 0.09 dB | 0.04 dB | 0.10 dB |
| 1.10 mm 03A | 0.20 dB | 0.18 dB | 0.14 dB | 0.14 dB |
| 1.10 mm 03B | 0.01 dB | 0.05 dB | 0.02 dB | 0.05 dB |
| 1.10 mm 04A | 0.01 dB | 0.04 dB | 0.01 dB | 0.04 dB |
| 1.10 mm 04B | 0.01 dB | 0.03 dB | 0.01 dB | 0.03 dB |

The tests results show no major issue with repeatably mating the LC connector with the fibre element fixed in the rear body to a conventionally-made LC connector.

On the other hand, Table 5 shows the result of randomly mating two connectors which both have the fibre unit sheath bonded to the rear body 502.

TABLE 5
Mating two connectors both with optional bonding

| Launch Lead | Sample Number | 1310 nm | 1550 nm |
|---|---|---|---|
| 1.05 mm 03B | 1.05 mm 04A | 0.30 dB | 0.23 dB |
| 1.05 mm 03A | 1.05 mm 04B | 0.05 dB | 0.13 dB |
| 1.10 mm 03B | 1.10 mm 04A | 0.31 dB | 0.25 dB |
| 1.10 mm 03A | 1.10 mm 04B | 0.13 dB | 0.15 dB |
| 1.05 mm 03B | 1.10 mm 04A | 0.32 dB | 0.26 dB |
| 1.05 mm 03A | 1.10 mm 04B | 0.10 dB | 0.12 dB |
| 1.10 mm 03B | 1.05 mm 04A | 0.30 dB | 0.19 dB |
| 1.10 mm 03A | 1.05 mm 04B | 0.20 dB | 0.25 dB |

These results include some loss values much higher than those seen in Table 3 or 4, for example. We conclude that, when randomly mated with both halves having a fibre unit fixed in the rear connector body in the region X, then the mating displacement does cause potential increases in loss, which may be as a result of micro-bending of one or both of the optical fibres under compression. Accordingly, unless the additional strength is required, it may be better to rely only on the bonding within the ferrule holder, as in the first embodiment.

Table 6 shows results of the “snatch” test, simulating accidental pulling of the cable and connector. These tests were performed with the modified LC connector 500, described above with reference to FIG. 5. In the samples for Table 6, the fibre unit sheath was bonded to the connector rear body 504 (third example). Optical performance of the connector (insertion loss) was measured before and after pulling out and reinserting the connector, and the force required to pull out the connector was recorded.

TABLE 6
Snatch test results (with optional bonding)

| | 1550 nm | Force | 1550 nm |
|---|---|---|---|
| | (Before) | (N) | (After) |
| 1.05 mm 3A | 0.09 dB | 14.8N | 0.11 dB |
| 1.05 mm 3B | 0.08 dB | 14.2N | 0.09 dB |
| 1.05 mm 4A | 0.11 dB | 19.4N | 0.08 dB |
| 1.05 mm 4B | 0.12 dB | 15.9N | 0.14 dB |
| 1.10 mm 3A | 0.29 dB | 15.2N | 0.28 dB |
| 1.10 mm 3B | 0.11 dB | 18.2N | 0.11 dB |
| 1.10 mm 4A | 0.08 dB | 18.8N | 0.10 dB |
| 1.10 mm 4B | 0.04 dB | 14.8N | 0.08 dB |

The same tests were performed in an assembly 600 (first embodiment), such that all the pulling force was through the fibre unit being bonded to the ferrule holder 604, as shown in FIG. 8(c). The results are shown in Table 7.

TABLE 7
Snatch test results (with no additional bonding)

| | 1550 nm | Snatch | 1150 nm |
|---|---|---|---|
| | (Before) | (N) | (After) |
| 1.05 mm 5A | 0.14 dB | 19.7N | 0.12 dB |
| 1.05 mm 5B | 0.15 dB | 16.4N | 0.17 dB |
| 1.05 mm 6A | 0.10 dB | 21.2N | 0.10 dB |
| 1.05 mm 6B | 0.16 dB | 20N | 0.17 dB |
| 1.10 mm 5A | 0.07 dB | 20N | 0.07 dB |
| 1.10 mm 5B | 0.09 dB | 17.9N | 0.06 dB |
| 1.10 mm 6A | broken | 18.3N | n/a |
| 1.10 mm 6B | broken | 16N | n/a |

Of the eight samples, assembly 6 broke in the ceramic optical ferrule during termination and for this reason it was not possible to measure the insertion loss, however snatch tests were still performed and recorded.

The results in Table 6 and Table 7 confirm that it is possible to “snatch out” the connector by pulling on the fibre unit, and that the connector will disengage from its mating adapter or socket, well before the maximum load is reached, that would compromise the connection between the fibre unit and the connector. No increase in insertion loss is seen as a result of the snatch test. The constructions disclosed herein therefore provide effective protection for the optical fibre without the need for additional sleeves and reinforcing elements.

### Blowing Performance Tests and Test Results

As explained already fibre unit 110 can be optimised for installation by blowing. Ideally, the blowing performance of the modified fibre unit with the sheath material based on PBT should be as good as or even better than the highly successful blown fibre unit with HDPE sheath, described in WO2004015475A2.

As a first test for suitability for blowing installation, friction tests illustrated in FIG. 12, have been performed on PBT-sheathed fibre units 110 with the construction shown in FIG. 3, in comparison with the known HDPE-sheathed fibre unit. As shown in FIG. 12(a), friction was measured relative to commercially available micro-ducts having outer/inner diameter 7/4 mm and having a low-friction HDPE liner. Some tests were performed with a micro-duct 1220A having a ribbed profile in the liner, and other tests performed with the micro-duct 1220B having a smooth liner, but otherwise identical. As shown in FIG. 12(b), the wrap angle θ for these tests was 450° (1¼ full turn). Tension was provided by a 200 g weight, giving a force T₂ of 1.962 N. Tension T₁ was recorded whilst pulling at a constant speed of 500 mm/min using a calibrated Lloyds tensile machine and 100 N load cell. Ten tests were conducted on each fibre unit/micro-duct combination. A fresh length of micro-duct and fibre was used for each test.

The fibre unit tested was the fibre unit 110 of FIG. 3 having two active fibres and two dummy fibres, and having 1.05 mm outside diameter (OD) with low-friction PBT sheath including the MB50-002 additive. The outer surface of this sheath is smooth, though ribbing or other texture could be provided if desired. The construction and dimensions of the coated fibre bundle are identical between the two examples, the difference being entirely in the sheath. The first fibre unit tested as a comparative example was the commercially available Emtelle fibre unit having two active fibres and two dummy fibres, and having 1.1 mm outside diameter (OD) with low-friction HDPE sheath. The sheath of this unit has longitudinal ribs.

Coefficients of friction μ were calculated using a form of the capstan equation (Equation 1).

$$μ = ln \frac{{T}_{1}}{{T}_{2}} / θ \qquad Eq . 1$$

The results were as shown in the following Tables 8A (ribbed micro-duct) and 8B (smooth micro-duct).

TABLE 8A
(COEFFICIENT OF FRICTION μ -
(7/4 MM RIBBED MICRO-DUCT)

| | 1.1 mm | 1.05 mm |
|---|---|---|
| Test | 2-FU HDPE | 2-FU PBT |
| 1 | 0.083 | 0.034 |
| 2 | 0.085 | 0.039 |
| 3 | 0.083 | 0.010 |
| 4 | 0.079 | 0.048 |
| 5 | 0.087 | 0.043 |
| 6 | 0.035 | 0.052 |
| 7 | 0.039 | 0.046 |
| 8 | 0.031 | 0.051 |
| 9 | 0.044 | 0.052 |
| 10 | 0.039 | 0.048 |
| Mean | 0.061 | 0.043 |

TABLE 8B
(COEFFICIENT OF FRICTION μ -
7/4 MM SMOOTH MICRO-DUCT)

| | 1.1 mm | 1.05 mm |
|---|---|---|
| Test | 2-FU HDPE | 2-FU PBT |
| 1 | 0.108 | 0.067 |
| 2 | 0.098 | 0.063 |
| 3 | 0.100 | 0.051 |
| 4 | 0.108 | 0.051 |
| 5 | 0.102 | 0.065 |
| 6 | 0.111 | 0.063 |
| 7 | 0.098 | 0.066 |
| 8 | 0.105 | 0.063 |
| 9 | 0.107 | 0.056 |
| 10 | 0.102 | 0.051 |
| Mean | 0.103 | 0.058 |

Without ascribing any significance to the absolute values of these results, what is clear from the tests is that the PBT-sheathed fibre unit of the present disclosure has a significantly lower coefficient of friction than the conventional HDPE-sheathed fibre unit. Moreover, the combination of a PBT-sheathed fibre unit and ribbed lining of the micro-duct provides the lowest friction of the four situations. Accordingly, in conjunction with a commercially available ribbed micro-duct, the PBT-sheathed fibre unit may be expected to perform even better in blowing the blowing method of installation. Of course, reduced friction would also indicate better performance in both pushing and pulling methods as well.

Having said that, blowing performance in a real application depends on many variables as well as the coefficient of friction. Various different testing regimes of blowing performance are known and used in the industry, including standard tests and custom tests for individual manufacturers and/or customers.

A long-established test, and one which is generally very challenging for blown fibre products, is the 500 m drum test.

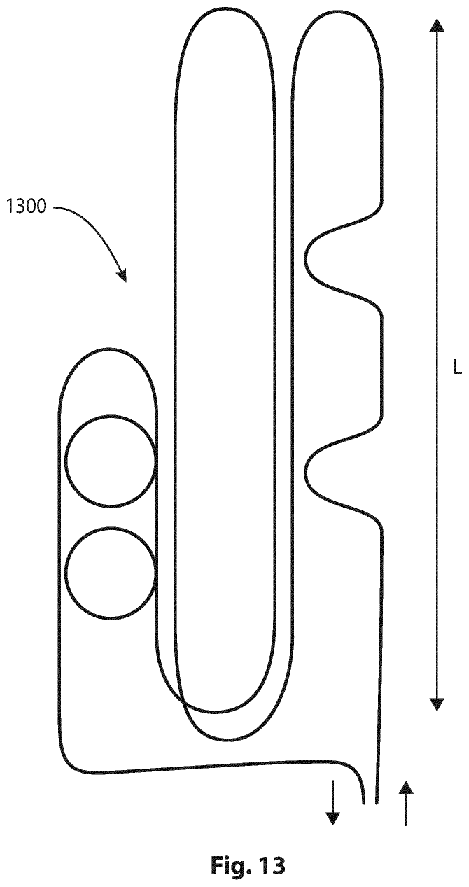

For this test, 500 metres of a commercially available tube with outside diameter 5 mm and internal diameter 3.5 mm with smooth low-friction HDPE lining was wound onto a drum with barrel diameter of 500 mm. A length of fibre unit 1302′ with outer diameter 1.05 mm was made according to the example of FIG. 13(c). The PBT outer sheath had 3% of the additive MB50-002. The end of the fibre unit was bare, without termination. An Accelair2 blowing machine was used, supplied with air by a Kaeser M31 air compressor. Other makes of equipment are of course available.

The results are shown in Table 9. The fibre unit was installed successfully through the entire length in under 20 minutes. The cable travelled at a constant speed of 30 m/min. The air pressure and driving torque of the blowing machine were adjusted in the usual manner.

TABLE 9
((Blowing 500 m Drum Test; Micro-duct 5/3.5 mm Smooth)

| | | | Air | |
|---|---|---|---|---|
| Distance | Time | Speed | Pressure | |
| (m) | (mm:ss) | (m/min) | (bar) | Torque |
| 0 | 0 | 30 | 0 | 30% |
| 50 | 2.06 | ″ | 6 | 35% |
| 100 | 4.1 | ″ | 8 | 40% |
| 150 | 5.48 | ″ | ″ | ″ |
| 200 | 7.3 | ″ | 10 | ″ |
| 250 | 9.1 | ″ | ″ | ″ |
| 300 | 10.4 | ″ | ″ | ″ |
| 350 | 12.1 | ″ | ″ | ″ |
| 400 | 13.4 | ″ | ″ | ″ |
| 450 | 15.1 | ″ | ″ | ″ |
| 500 | 17.4 | ″ | ″ | ″ |
| 550 | 19.1 | 30 | 10 | 40% |
| 600 | | | | |

Further blowing tests were performed with the route 1300 shown schematically in FIG. 13. The route was 500 m in total using a 7/3.5 mm tube, and included various features, namely two simulated road crossings with 150 mm bend radius, two 180-degree bends with a radius of 200 mm, two 180-degree bends with a 150 mm radius, one 180-degree bend with 500 mm radius and two 360-degree loops with radius 300 mm. The overall length L of each section was 100 m.

Blowing was performed using lengths of fibre unit 110 with outer diameter 1.05 mm made according to the example of FIG. 3. The PBT outer sheath had 3% of the additive MB50-002. The end of the fibre unit had a blowable ferrule sub-assembly 124 as termination.

Tests using this route were done with the fibre unit 110 soon after manufacture. The tests were then repeated with fibre unit 110 which had been subject to temperature cycling, specifically 2 cycles 12 hours prior to the blowing trial between-10 degrees Celsius and +50 degrees Celsius. Tests using this route were done with two different compressors, different to the one used in the drum test.

Results are shown in Table 10A and 10B (different compressors; fibre unit before temperature cycling) and Table 11A and 11B (different compressors; fibre unit after temperature cycling).

TABLE 10A
(Compressor 1; fibre unit before temperature cycling)

| | | | Air |
|---|---|---|---|
| Distance | Time | Speed | Pressure |
| (m) | (mm:ss) | (m/min) | (Bar) |
| 0 | 0:00 | 30 | 2 |
| 50 | 1:49 | 30 | 2 |
| 100 | 3:29 | 30 | 2 |
| 150 | 5:10 | 30 | 4 |
| 200 | 6:51 | 30 | 2 |
| 250 | 8:31 | 30 | 2 |
| 300 | 10:12 | 30 | 2 |
| 350 | 11:53 | 30 | 2 |
| 400 | 13:33 | 30 | 2 |
| 450 | 15:14 | 30 | 3.5 |
| 500 | 16:54 | 30 | 3.5 |

TABLE 10B
(Compressor 2; fibre unit before temperature cycling)

| | | | Air |
|---|---|---|---|
| Distance | Time | Speed | Pressure |
| (m) | (mm:ss) | (m/min) | (Bar) |
| 0 | 00:00 | 46 | 0 |
| 50 | 01:11 | 34 | 0 |
| 100 | 02:15 | 46 | 2 |
| 150 | 03:22 | 46 | 2 |
| 200 | 04:27 | 46 | 2 |
| 250 | 05:35 | 46 | 2 |
| 300 | 06:41 | 46 | 2 |
| 350 | 07:45 | 46 | 2 |
| 400 | 08:50 | 46 | 2 |
| 450 | 09:56 | 46 | 2 |
| 500 | 11:01 | 46 | 2 |

TABLE 11A
(Compressor 1; fibre unit after temperature cycling)

| | | | Air |
|---|---|---|---|
| Distance | Time | Speed | Pressure |
| (m) | (mm:ss) | (m/min) | (Bar) |
| 0 | 00:00 | 35 | 2 |
| 50 | 01:37 | 35 | 2 |
| 100 | 03:02 | 35 | 2 |
| 150 | 04:26 | 35 | 4 |
| 200 | 05:50 | 35 | 4 |
| 250 | 07:20 | 35 | 4 |
| 300 | 08:42 | 35 | 4 |
| 350 | 10:07 | 35 | 4 |
| 400 | 11:32 | 35 | 4 |
| 450 | 12:59 | 35 | 4 |
| 500 | 14:23 | 35 | 4 |

TABLE 11B
(Compressor 2; fibre unit after temperature cycling)

| | | | Air |
|---|---|---|---|
| Distance | Time | Speed | Pressure |
| (m) | (mm:ss) | (m/min) | (Bar) |
| 0 | 00:00 | 35 | 0 |
| 50 | 01:29 | 35 | 2 |
| 100 | 02:56 | 35 | 2 |
| 150 | 04:26 | 45 | 2 |
| 200 | 05:47 | 45 | 4 |
| 250 | 06:53 | 45 | 4 |
| 300 | 08:14 | 50 | 4 |
| 350 | 09:16 | 50 | 4 |
| 400 | 10:15 | 50 | 4 |
| 450 | 11:16 | 50 | 4 |
| 500 | 12:14 | 50 | 4 |

These blowing tests have shown that the new fibre unit having a PBT outer sheath with PDMS additive and blowable ferrule sub-assembly can perform extremely well in blowing, requiring a very modest air pressure, especially bearing in mind the very convoluted route that has been laid out to simulate more challenging real-world installations. The temperature cycling did not adversely affect the blowing performance of the fibre units. The ability to install using lower air pressures has significant benefits in allowing the use of more lightweight and lower cost equipment. It can also be seen that the second compressor in the trial outperformed the first compressor considerably, with more than two minutes faster installation time.

It goes without saying that all of the above examples also achieve satisfactory optical performance under a range of environmental and mechanical conditions. The optical fibres used in the examples were single mode fibres compliant with G.657.A2 (ITU-T).

According to these test results, the optical fibre cable assemblies of the present disclosure can be pre-terminated and installed through a duct by blowing, without requiring the post-installation step of installing a protective outer jacket, for example a braided or woven sleeve, and without the pre-installation step of providing a blowable protective sleeve. Dozens or even hundreds of connections may be made in the same cabinet, meaning that the time and space saved can be significant. At the same time, the fibres can be subjected to repeated disturbance over their lifetime without being destroyed when accidentally pulled.

As mentioned, the cable assembly of the type disclosed herein can be installed by blowing, or by pushing, pulling, or by a combination of these processes. For pulling, it may be noted that ducts can be purchased which are pre-loaded with a pulling line.

FIG. 14 illustrates a pulling accessory 1402 that can be used with a pulling line, to install an optical fibre and/or optical fibre cable that has been pre-terminated with an optical ferrule 502 and ferrule holder 504. The fibre unit 110 (including its extruded polymer sheath 324) extends into the ferrule holder, where it is cemented as illustrated in FIG. 8. Two of the pulling accessories 1402 are illustrated, one fitted to the end of the optical fibre, and one spare. As can be seen, the pulling accessory 1402 has a recess 1404 tailored to fit over the pre-terminated end of the optical fibres, capturing the ferrule holder 504. At a rounded front end of the pulling accessory 1402, a pulling eye 1406 is provided, for attaching the pulling line (not shown). The pulling force that can be applied without risking damage to the fibres is of course limited, especially if the route includes bends. On the other hand, it is expected that the sheath of the present disclosure provides more protection against tensile force than the conventional loose HDPE sheath, so that pulling performance is enhanced compared with the known blown fibre unit. This additional tensile performance can be associated with the material properties of the PBT material (with additive) and/or the greater tightness of the sheath on the solid coated fibre bundle.

As is known by the skilled person, the distance that a length of optical fibre cable that can be installed by pulling or pushing may be significantly less than the distance that can be obtained by blowing, but it may be adequate, for example for short drops within a building, or from street to building. Providing a versatile cable assembly that can be used in two or three different modes of installation allows installation to be performed by a mixture of blowing, pulling and pushing, for different segments of a single building or district network. This avoids, for example, being forced to use complicated blowing procedures for even the shortest drop, or having to specify different types of cable for different segments. Pre-terminated assemblies can be provided in a mixture of different lengths, tailored to the particular combination of lengths required in a particular installation job.

FIG. 15 illustrates another example of a pre-terminated optical fibre cable assembly 1500 constructed in accordance with the principles of the present disclosure. This example is a length of optical fibre cable or fibre unit 1510, which is pre-terminated at both ends with ferrule sub-assemblies 124a and 124b. The fibre unit 1510, as delivered, is coiled in a pan 1512 or wound on a reel, in the conventional manner. The types of connectors at the different ends can be the same or different. The choice of construction among the embodiments describe above may be different at the different ends. In particular, it is envisaged that one of the ends of the cable assembly 1500 might be installed by blowing, over a large distance, say, while the other end is installed over a shorter distance, for example by blowing, pushing or pulling. One of the ends may terminate at a communications cabinet, while the other end terminates within a consumer premises, such as a house or office.

FIG. 16 illustrates an example of such an installation, using the double-ended pre-terminated cable assembly of FIG. 15. Compared with the situation shown in FIG. 1, a consumer access point 1604 is on an upper storey of the building 1614. A first installation step is illustrated in FIG. 16(a) and a second installation step is illustrated in FIG. 16(b). The first installation step corresponds, for example, exactly to the blowing installation process described above with reference to FIGS. 1 and 2. From an access point 102 on the exterior of the building 1614, a first end of the cable assembly 1500 is installed by blowing to the cabinet 116 via duct 120a. The installation distance may be hundreds of metres or more. At the end of this first installation step, the second end of the cable assembly, and a coil of excess cable, remain at the access point.

In the second installation step illustrated in FIG. 16(b), the second end of the cable assembly 1500 is installed into a local drop duct 120b, to reach a particular apartment or room within the building 1614. As illustrated, this may be a consumer's connection point 1604 on an upper floor of the building. This installation step, which may comprise only a few metres of cable, may be performed by manual pushing, pulling or blowing if necessary. Within the consumer premises, the connector body can be added to the ferrule sub-assembly. Excess cable 1510 can be stored at a suitable point on the installation, for example in the home/office at connection point 1604, or in a termination housing 102 at the side of the building (as shown in FIG. 16), or at some point in between. When the cable assembly 110 or 1500 is lightweight and compact to begin with, storing the excess length is not a burden.

### Further Example Pushable and Blowable Cable

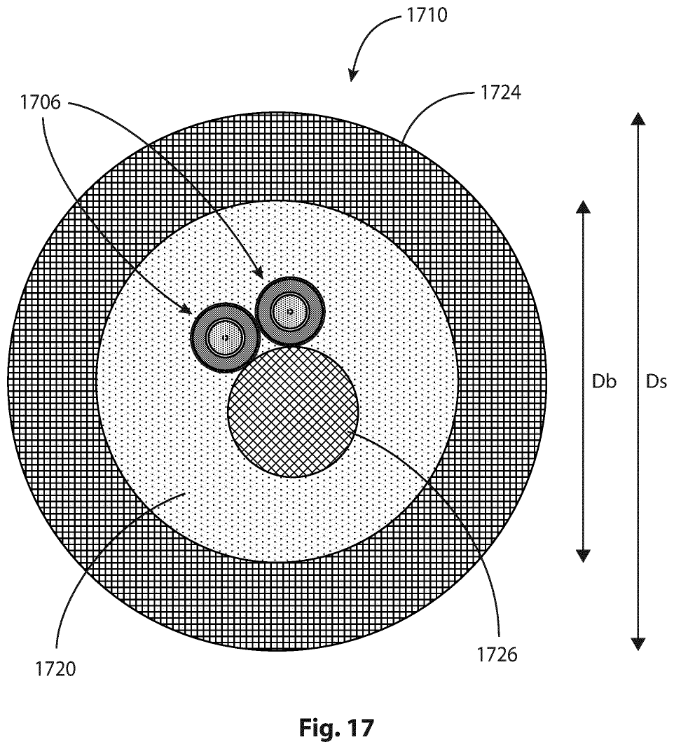

FIG. 17 shows in schematic cross-section a further example fibre optic cable 1710 which is also blowable, but is optimised for pushing installation as well. This type of cable, sometimes referred to as “nanocable” is of similar construction to the fibre unit 110, but the coated fibre bundle includes at least one strength member. Thus, a number of optical fibres 1706 are embedded in a solid resin material 1720 to form a coated fibre bundle, as before. The extruded sheath 1724 surrounds the coated fibre bundle, also as before. However, the coated fibre bundle in this example additionally includes a longitudinal strength member 1726, made for example of fibre reinforced plastic (FRP). As is well known, such a strength member provides a degree of stiffness against bending, as well as strength against tensile forces. The number of optical fibres may be only one, although two are shown. The strength member in this example is shown with a diameter of approximately 0.5 mm. An outer diameter of the fibre unit 1710 may be greater than that of the examples of FIG. 3, being for being for example in the range of 1.2 to 2.5 mm, for example in the range 1.2 to 2.0 mm, for example 1.2 to 1.8 mm.

The extruded sheath 1724 in this example may have a thickness greater than that of fibre unit 110. The extruded sheath 1724 in this example may have a thickness in the range 0.25 to 0.4 mm, for example 0.3 to 0.35 mm, similar to a known nanocable. The extruded sheath may be made of a HDPE with reduced friction, or another polymer. If the polymer is substantially stronger and/or stiffer than HDPE, the sheath thickness may be reduced. For example, in the case of the PBT material with friction reducing additives mentioned above, it may be preferred to reduce the sheath thickness to less than 0.3 mm, less than 0.25 mm or even less than 0.15 mm or less than 0.12 mm.

In a known product of this design, with an HDPE-based sheath, such a cable has been found to have good blowing performance and excellent pushing performance. For example, with a ferrule sub-assembly pre-fitted on the end, a 2-fibre example has been pushed over 90 m through buried micro-duct of 7/3.5 mm dimensions with no difficulty. The lower friction of the PBT-based sheath may be expected to perform even better. Again, the higher tensile stiffness and strength of the PBT-based sheath may also be expected to provide excellent pulling characteristics as well.

In versions with more fibres, the additional strength member may be unnecessary to provide adequate stiffness for pushing. For example, a coated fibre bundle of 12 optical fibres is suitable for blowing and for pushing, without having the additional strength member 1726. A 12-fibre example with PBT-based sheath material and 1.8 mm outer diameter Ds has been pushed 100 m through a micro-duct of 6/3.2 mm size.

Note that coated optical fibres are now readily available in 0.2 mm diameter (200 micron), as well as 0.25 mm. Such smaller fibres can be used instead of 0.25 mm fibres in any of the above designs, with a corresponding reduction in the size of all layers, if desired.

### CONCLUSION

Using pre-terminated assemblies in the manner described, improves the installation process, by reducing post-installation steps and time. As such, production costs and assembly costs may be reduced compared with applying a protective sleeve, in particular a braided or woven sleeve. As mentioned above, this saves space and therefore facilitates more installations within one cabinet.

Additionally, following the principles of the present disclosure, the delicate steps of fibre termination and assembly of the entire pre-terminated optical fibre cable assembly with protective sleeves can be performed in a controlled factory environment, rather than in the field. Nor does any element of the assembly need to be precisely tailored to a particular installation. The enhanced sheath 324, bonded directly or indirectly to the connector, protects whatever length of optical fibre will be protruding from the duct. As described, these measures can be applied to only one end of the cable assembly, or to both ends. These measures can be applied especially to a compact and lightweight cable, of the type designed for installation by blowing, although the method of installation is by no means limited to blowing.

The present disclosure encompasses kits of parts for use in producing pre-terminated optical fibre cable assemblies of the type described, as well as the method of manufacturing such assemblies, and the stocking and distribution of such assemblies for installation, together with accessories involved in the installation. It will be appreciated that, for a commercial installation, several, perhaps tens or hundreds of individual pre-terminated cable assemblies may be provided, all of respective lengths with appropriate connector parts at one or both ends. For convenience and reliability, the connector body parts required for the completion of the connector for each pre-terminated cable assembly may be packaged together with that individual cable assembly, for example being tucked inside a cardboard or similar reel or pan (112, 1512) on which the cable is wound.

The present disclosure encompasses methods of installation, as described, as well as methods of manufacture, the cable assemblies and kits of parts for installing the cable assemblies, and also kits of parts for making the cable assemblies.

Whilst specific embodiments of the present invention have been described above, it will be appreciated that departures from the described embodiments may still fall within the scope of the present invention.

1. A pre-terminated optical fibre cable assembly configured to be installed through a duct, the pre-terminated optical fibre cable assembly comprising:
a length of cable comprising at least one optical fibre embedded in a solid resin material to form a coated fibre bundle and an extruded polymer sheath covering the coated fibre bundle;
a ferrule sub-assembly pre-arranged on at least a leading end of the cable, the ferrule sub-assembly being adapted to become, after installation through said duct, part of a pluggable optical connector for making an optical connection to said at least one optical fibre; and
a restraining part fixed to a portion of said extruded polymer sheath, the restraining part being optionally part of said ferrule sub-assembly, the restraining part being adapted, when said ferrule sub-assembly becomes part of said pluggable connector and when a pull-out force is applied to said pluggable connector by pulling on a trailing portion of the cable, to transfer at least 25 N of said pull-out force to a body of said pluggable connector while any of said pull-out force transferred to said optical fibre remains less than 5 N.

2. An assembly as claimed in claim 1 wherein said ferrule sub-assembly includes an optical ferrule and a ferrule holder, said optical ferrule being seated in a forward part of said ferrule holder, said optical fibre passing through a bore of said ferrule holder and extending into a bore of said optical ferrule.

3. An assembly as claimed in claim 2 wherein said ferrule sub-assembly further includes a spring for biasing the ferrule sub-assembly into contact with a mating connector, said spring being seated in a rear part of said ferrule holder.

4. An assembly as claimed in claim 1 wherein said restraining part is part of said ferrule sub-assembly.

5. An assembly as claimed in claim 2 wherein said restraining part is the ferrule holder of said ferrule sub-assembly, said portion of the sheath being bonded within a bore of said ferrule holder.

6. An assembly as claimed in claim 1 wherein said restraining part is fixed to said portion of the sheath at a position spaced behind said ferrule sub-assembly, and is adapted to engage a portion of a connector body for the transfer of said 25 N of the pull-out force.

7. An assembly as claimed in claim 6 wherein said restraining part comprises a cylindrical body surrounding said portion of the sheath.

8. An assembly as claimed in claim 7 wherein said restraining part further comprises a projection, optionally an annular projection, for engaging said portion of the connector body.

9. An assembly as claimed in claim 1 wherein said restraining part is fixed to said portion of the sheath by bonding.

10. An assembly as claimed in claim 9 wherein said bonding is by a thermoset resin, for example epoxy resin.

11. An assembly as claimed in claim 1 wherein said extruded polymer sheath is of a material having a tensile modulus in excess of 1500 MPa, optionally in excess of 2000 MPa, optionally in excess of 2200 MPa and optionally in excess of 2400 MPa.

12. An assembly as claimed in claim 1 wherein said extruded polymer sheath is of a material having a yield strength in excess of 30 MPa, optionally in excess of 40 MPa.

13. An assembly as claimed in claim 1, wherein said extruded polymer sheath comprises a mixture of polybutylene terephthalate polymer, (PBT) and at least one friction reducing additive.

14. An assembly as claimed in claim 13 wherein said friction reducing additive comprises a polydimethylsiloxane material, PDMS in a carrier material.

15. An assembly as claimed in claim 14 wherein said PDMS is an ultra-high molecular weight PDMS and said carrier material is a polyacrylate material, for example a copolymer of ethylene and methyl acrylate, EMA.

16. An assembly as claimed in claim 14 wherein said PDMS is an ultra-high molecular weight PDMS and said carrier material is a polyolefin, such as low-density polyethylene (LPDE).

17. An assembly as claimed in claim 16 wherein said additive comprises at least 40% by weight ultra-high molecular weight PDMS and said carrier material is low-density polyethylene (LPDE).

18. An assembly as claimed in claim 13 wherein the amount of friction reducing additive is between 1% and 5%, optionally between 2% and 4% by weight of the material of the extruded sheath.

19. A method of assembling a pre-terminated optical fibre cable assembly configured to be installed through a duct, the method comprises the steps of:
providing a length of cable comprising at least one optical fibre embedded in a solid resin material to form a coated fibre bundle and an extruded polymer sheath covering the coated fibre bundle;
prior to installation through said duct fixing a ferrule sub-assembly on a leading end of the length of cable, the optical ferrule being adapted to become, after installation through said duct, part of a pluggable optical connector for making an optical connection to said at least one optical fibre; and
prior to installation through said duct fixing a restraining part to a portion of said extruded polymer sheath, the restraining part being optionally part of said ferrule sub-assembly, the restraining part being adapted, when said ferrule sub-assembly becomes part of said pluggable connector and when a pull-out force is applied to said pluggable connector by pulling on a trailing portion of the cable, to transfer at least 25 N of said pull-out force to a body of said pluggable connector while any of said pull-out force transferred to said optical fibre remains less than 5 N.

20. A method as claimed in claim 19, wherein the pre-terminated optical fibre cable assembly is as claimed in claim 1.

21. A method as claimed in claim 19, wherein the pre-terminated optical fibre cable assembly is as claimed in claim 4.

22. A method as claimed in claim 19, wherein the pre-terminated optical fibre cable assembly is as claimed in claim 6.

23. A method as claimed in claim 19, wherein the pre-terminated optical fibre cable assembly is as claimed in claim 9.

24. A method of installing a pre-terminated optical fibre cable assembly according to claim 1, the method comprising the steps of:
inserting the leading end of said cable including said ferrule sub-assembly into a duct;
transporting a length of the cable through the duct until a leading portion of the cable protrudes from the duct; and
adding a connector body to the ferrule sub-assembly to complete said pluggable optical connector, at least a part of said connector body engaging with the restraining part for the transfer of said pull-out force.

25. A kit of parts for installing an optical fibre cable, the kit of parts comprising:
a pre-terminated optical fibre cable assembly according claim 1; and
a connector body for adding to the ferrule sub-assembly to complete said pluggable optical connector, at least a part of said connector body being adapted to engage with the restraining part of the pre-terminated optical fibre cable assembly for the transfer of said pull-out force.

26. A kit of parts for use in making a pre-terminated optical fibre cable assembly, the kit of parts comprising:
a length of cable comprising at least one optical fibre embedded in a solid resin material to form a coated fibre bundle and an extruded polymer sheath covering the coated fibre bundle;
at least one ferrule sub-assembly adapted to be arranged on a leading end of the length of cable prior to installation of the cable through a duct, the ferrule sub-assembly being adapted to become, after installation through said duct, part of a pluggable optical connector for making an optical connection to said at least one optical fibre; and
a restraining part which is optionally part of said ferrule sub-assembly, the restraining part being adapted to be fixed to a portion of said extruded polymer sheath prior to installation of the cable through the duct,
wherein said restraining part is adapted, when fixed to said portion of the sheath and when said terminating ferrule becomes part of said pluggable connector and when a pull-out force is applied to said pluggable connector by pulling on a trailing portion of the cable, to transfer at least 25 N of said pull-out force to a body of said pluggable connector while any of said pull-out force transferred to said optical fibre remains less than 5 N.
